(19) United States
(12) Patent Application Publication
(10) Pub. No.: US 2022/0167788 A1
(43) Pub. Date: Jun. 2, 2022

(54) Cooking Appliance, Method and System

(71) Applicant: BREVILLE USA, INC., Torrance, CA (US)

(72) Inventors: Calvin Oh, Torrance, CA (US); Christopher Charles Young, Torrance, CA (US); Claire Gottschalk, Torrance, CA (US); Ricky Castro, Torrance, CA (US)

(73) Assignee: BREVILLE USA, INC., Torrance, CA (US)

(21) Appl. No.: 17/441,282

(22) PCT Filed: Mar. 19, 2020
(86) PCT No.: PCT/US20/23606

§ 371 Date: Sep. 20, 2021

Related U.S. Application Data
(60) Provisional application No. 62/820,799, filed on Mar. 19, 2019.

(51) Int. Cl. A47J 36/32; A23L 5/10; A47J 27/08; G05B 19/042

(52) U.S. Cl. CPC A47J 36/321; A23L 5/15; A47J 27/0802; G05B 2219/2643; A23V 2002/00; A47J 2203/00; G05B 19/042

(57) ABSTRACT

A cooking appliance generates a recipe based on detected weights of multiple ingredients and receives a parameter for cooking the food. In another aspect, the cooking appliance can receive a recipe defining a process for cooking food and an amount of at least a first ingredient in the recipe for the food. Based on the recipe and the amount of the first ingredient added to the container, the cooking appliance generates a wirelessly output instruction for cooking the food. In another aspect, a processor of the cooking appliance detects a physical state of the cooking appliance responsive to an electrical signal and applies a setting to the cooking appliance to cook the food. The cooking appliance can include an LED gauge including multiple LEDs. The processor can selectively turn on one or more of the LEDs based on the set parameter value of the cooking appliance.

### RELATED APPLICATIONS

The present application claims priority from U.S. Provisional Patent Application No. 62/820,799, filed 19 Mar. 2020, which is herein incorporated by reference in its entirety.

### TECHNICAL FIELD

The present invention relates to cooking appliances, method and system.

### BACKGROUND

Cooking food often entails performing a number of steps, including identifying ingredients in the food or a recipe, measuring appropriate quantities of each ingredient, and selecting an amount of time and a temperature at which the ingredients should be cooked to produce food that is safe and enjoyable to eat. The steps of a cooking process are typically interrelated, such that changing one component affects the outcome of the food unless other components are similarly changed. Because it can sometimes be difficult for people to accurately measure all components while they are cooking and ensure that any adjustment to a component results in equivalent adjustments to other components, different outcomes may result each time a food item is cooked. Furthermore, it can be difficult for a person to recreate a food item he or she prepared or to accurately communicate the preparation process to another person for the other person to recreate the food item.

Furthermore, many people use cooking appliances to assist in the preparation of food. Cooking appliances can simplify food preparation, for example by regulating properties such as temperature and pressure. However, it can sometimes be inconvenient for users to interact with appliances while cooking. Users' hands may be occupied, for example, handling ingredients for a recipe, thus making it inconvenient for the user to interact with complicated user interfaces to apply settings to the appliance. Understanding information output by cooking appliances can also be challenging at times. For example, if a cooking appliance displays only numerical values for its settings, a user who is focused on measuring ingredient amounts or other numbers related to a recipe may not notice that the temperature of the appliance is set incorrectly. Cooking appliances therefore would benefit from convenient, intuitive ways for users to interact with the appliance that reduce cognitive burden on the user.

### SUMMARY

It is an object of the present invention to substantially overcome or at least ameliorate one or more disadvantages of existing arrangements or provide a useful alternative.

In a first aspect there is provided a cooking appliance, comprising: a scale; a processor coupled to the scale; and a non-transitory computer readable storage medium storing executable computer program instructions, the computer program instructions when executed by the processor causing the processor to: detect, using the scale, weights of each of multiple ingredients of food added to a container associated with the cooking appliance; receive a parameter of the cooking appliance for cooking the food; and generate based on the weights and the received parameter, a recipe defining a process for cooking the food.

In a second aspect there is provided a cooking appliance comprising: a processor coupled to the scale; and a non-transitory computer readable storage medium storing executable computer program instructions, the computer program instructions when executed by the processor causing the processor to: receive at least a portion of a recipe, wherein the recipe defines a process for cooking food and an amount of at least a first ingredient in the recipe for the food; determine an amount of the first ingredient added during execution of the recipe; generate an instruction for cooking the food based on the amount of the first ingredient added; and wirelessly output the instruction by the cooking appliance.

In a third aspect there is provided a system comprising: a cooking appliance configured according to the first aspect; and another cooking appliance configured according to the second aspect; wherein the processor of the cooking appliance is configured to transfer the instruction to generate a command to cause the another cooking appliance to perform an action.

In a fourth aspect there is provided a method, comprising: detecting, at a cooking appliance which comprises a scale, weights of each of multiple ingredients of food added to a container associated with the cooking appliance; receiving, at the cooking appliance, a parameter of the cooking appliance for cooking the food; and generating, by the cooking appliance and based on the weights and the received parameter, a recipe defining a process for cooking the food.

In a fifth aspect there is provided a method comprising: receiving at a cooking appliance, at least a portion of a recipe, wherein the recipe defines a process for cooking food and an amount of at least a first ingredient in the recipe for the food; determining by the cooking appliance, an amount of the first ingredient added during execution of the recipe; generating an instruction for cooking the food based on the amount of the first ingredient added; and wirelessly outputting the instruction by the cooking appliance.

In a sixth aspect there is provided a cooking appliance, comprising: a base configured to support a cooking container and to electrically couple to the cooking container to cause food in the cooking container to be cooked; a scale housed in the base; and a processor coupled to the scale, the processor executing computer program code that causes the processor to: detect a physical item has been added to or removed from the base using a weight measured by the scale; and responsive to detecting the physical item has been added or removed, apply a setting to the cooking appliance, based on the detection of the physical item, to cook the food in the cooking container.

In a seventh aspect there is provided a cooking appliance, comprising: a light emitting element gauge including multiple light emitting elements; and a processor coupled to the gauge and executing computer program code that causes the processor to: detect a parameter value applied to the cooking appliance, the parameter value selected from a specified range of possible values for a parameter of the cooking appliance; and selectively turn on one or more of the multiple light emitting elements in the gauge based on the parameter value in proportion to the range of possible values.

In an eighth aspect there is provided a method comprising: detecting a physical state associated with the cooking appliance responsive to an electrical signal detected by a processor, wherein the cooking appliance comprises a base configured to support a cooking container and electrically couple to the cooking container to cause food in the cooking container to be cooked, and the processor housed in the base; and responsive to detecting the physical state, applying a setting to the cooking appliance, based on the detected physical state, to cook the food in the cooking container.

In a ninth aspect there is provided a method comprising: detecting a parameter value applied to the cooking appliance, the cooking appliance comprising a light emitting element gauge including multiple light emitting elements, and a processor coupled to the gauge, the parameter value selected from a specified range of possible values for a parameter of the cooking appliance; and selectively turning on one or more of the multiple light emitting elements in the gauge based on the parameter value in proportion to the range of possible values.

In a tenth aspect there is provided a non-transitory computer readable medium including executable instructions which when executed by a processor of a cooking appliance configured the cooking appliance to perform the method of any one of the fourth, fifth, eighth and ninth aspects.

Other aspects and embodiments of the disclosed technology will be further appreciated throughout the detailed description.

### BRIEF DESCRIPTION OF THE DRAWINGS

Example embodiments should become apparent from the following description, which is given by way of example only, of at least one preferred but non-limiting embodiment, described in connection with the accompanying figures.

FIG. 1A is a block diagram illustrating one embodiment of an environment in which a cooking appliance operates.

FIG. 1B illustrates an exemplary social feed generated within a cooking social network.

FIGS. 2A-2F illustrate an exemplary cooking appliance.

FIGS. 3A-3B illustrate another exemplary cooking appliance.

FIG. 4A is a block diagram illustrating functional modules executed by a cooking appliance.

FIG. 4B illustrates an exemplary recipe data structure.

FIG. 4C is a flowchart illustrating a process for guiding a user to add specified quantities of ingredients to food.

FIG. 5 is a flowchart illustrating a process for generating a recipe using a cooking appliance.

FIG. 6 is a flowchart illustrating a process for applying a recipe at a cooking appliance.

FIGS. 7A-7D illustrate example display devices of a cooking appliance.

FIG. 8 is a flowchart illustrating a process for a cooking appliance to manage user interactions with the appliance.

FIG. 9 is a block diagram illustrating an exemplary of a processing system in which at least some operations described herein can be implemented.

### DETAILED DESCRIPTION

In one aspect there is provided a cooking appliance which automatically captures recipes and guides a user through a recipe while the user is cooking with the appliance. While a user is cooking food, the cooking appliance can capture information such as identity and quantities of ingredients the user uses, settings the user applies to the cooking appliance, and actions performed by the user. The captured information can be used to generate a recipe, which can be stored by the cooking appliance for subsequent use by the user or distributed to other cooking appliances for other users to follow. A user can also use the cooking appliance to cook food using a recipe. Based on a recipe, the cooking appliance can generate dynamic instructions that guide the user through the cooking process and respond to any changes the user makes to the recipe. The cooking appliance can process and respond to conversational inputs from the user. The cooking appliance can also communicate with one or more other cooking appliances to synchronize their cooking processes.

In some embodiments, a cooking appliance comprises a scale, a processor coupled to the scale, and a non-transitory computer-readable storage medium storing executable computer program instructions. When the instructions are executed by the processor, the instructions cause the processor to detect, using the scale, weights of each of multiple ingredients of a food item added to a container associated with the cooking appliance. The processor receives a parameter of the cooking appliance for cooking the food. Based on the weights and the received parameter, the processor generates a recipe defining a process for cooking the food.

In some embodiments, a cooking appliance receives a recipe defining a process for cooking a food item and an amount of at least a first ingredient in the recipe for the food item. The cooking appliance determines an amount of the first ingredient added to a container associated with the cooking appliance. Based on the recipe and the amount of the first ingredient added to the container, the cooking appliance generates an instruction for cooking the food and wirelessly outputs the instruction.

In additional or alternate aspects there is provided a cooking appliance which facilitates convenient, automatic user interactions with the appliance as the user cooks. The appliance interacts with the user by, for example, detecting physical states of the appliance as the user adds or removes items from the appliance, applying settings to the appliance based on the physical states, and/or outputting information, such as appliance settings, to the user in a manner that communicates the information quickly and clearly to reduce cognitive burden on the user.

In at least one implementation or embodiment, a cooking appliance comprises a base configured to support a cooking container and electrically couple to the cooking container to cook food in the cooking container. The cooking appliance can also comprise a scale housed in the base and a processor coupled to the scale. The processor can execute computer program code that causes the processor to detect when a physical item (such as the cooking container or a lid) has been added to or removed from the base using a weight measured by the scale. In response to detecting the physical item has been added or removed, the processor applies a setting to the cooking appliance (adjust temperature or cooking time) to cook the food in the cooking container.

In another embodiment, a cooking appliance comprises a light gauge made of, e.g., multiple emitting diodes (LEDs), and a processor coupled to the LED gauge. The processor can execute computer program code that causes the processor to detect a parameter value applied to the cooking appliance, where the parameter value is selected from a specified range of possible values for the parameter of the cooking appliance. To provide a visual representation of the parameter, which can be, for example, temperature, pressure, or fill level of the appliance, the processor can selectively turn on one or more of the LEDs in the gauge based on the parameter value in proportion to the range of possible values.

In some embodiments, a cooking appliance comprises a base configured to support a cooking container and electrically couple to the cooking container to cause food in the cooking container to be cooked. A processor housed in the base executes computer program code that causes the processor to detect a physical state associated with the cooking appliance, such as the fill level of the cooking container, thermal resistance of the cooking container, or the presence or absence of components such as a lid or accessories for the cooking appliance. The processor applies a setting to the cooking appliance, based on the detected physical state, to cook the food in the cooking container.

Various examples of the invention will now be described. The following description provides certain specific details for a thorough understanding and enabling description of these examples. One skilled in the relevant technology will understand, however, that the invention can be practiced without many of these details. Likewise, one skilled in the relevant technology will also understand that the invention can include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

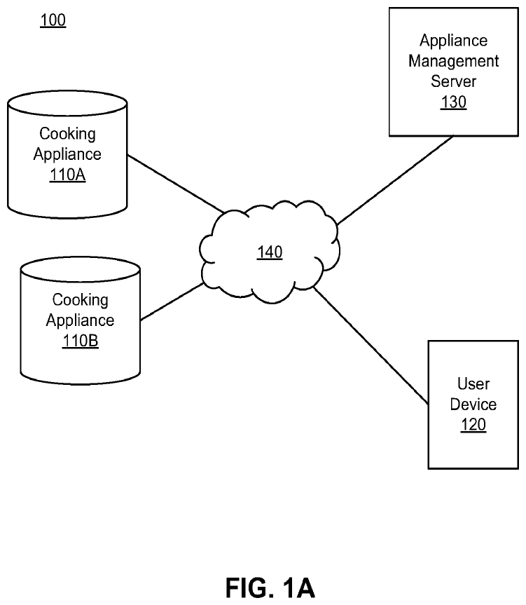

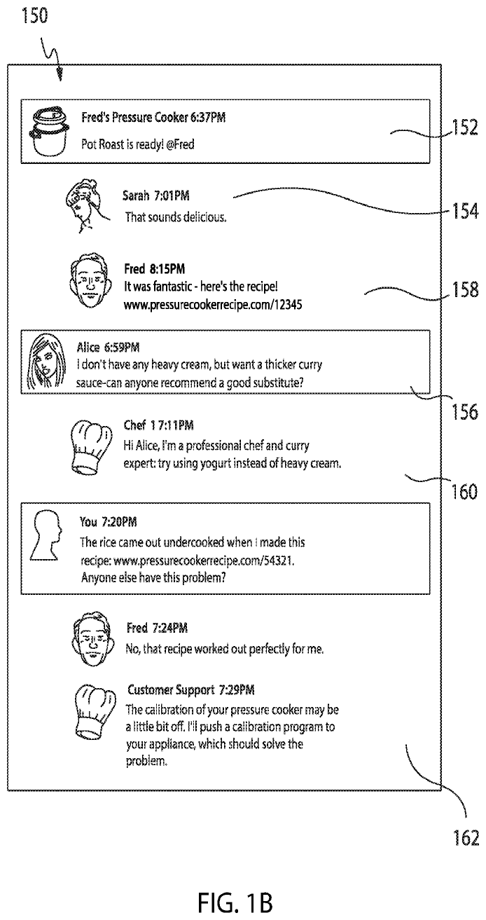

FIG. 1A is a block diagram illustrating one embodiment of an environment 100 in which a cooking appliance operates. As shown in FIG. 1A, the environment can include one or more cooking appliances 110, at least one user device 120, and at least one appliance management server 130. The appliances 110, user device 120, and/or server 130 can communicate over a network 140, comprising one or more wired or wireless local area networks (LANs), wide-area networks (WANs), metropolitan area networks (MANs), and/or the Internet. Alternatively, devices in the environment 100 can communicate over direct wired or wireless connections. For example, the cooking appliance 110A can communicate with the cooking appliance 110B over a Wi-Fi Direct connection, or the user device 120 may communicate with a cooking appliance 110 over a Bluetooth connection.

The cooking appliances 110 are devices used in a process to prepare food items. Exemplary cooking appliances 110 can include pressure cookers, immersion circulators, scales, multi cookers, or any other appliances that can be used to capture information about food or perform an action on food during a process to prepare the food for consumption. In one form, the one or more appliances 110 can be a multi-cooker such as a kitchen device as disclosed in International Patent Application No. PCT/AU2019/050681, filed 28 Jun. 2019, which is herein incorporated by reference in its entirety. The cooking appliances 110 can be associated with a container that holds or supports an ingredient or food item. The container can be integrated into the cooking appliance 110 (such as a vessel of a pressure cooker) or can be separate from and used with an appliance 110 (such as a bowl that holds an ingredient while the ingredient is weighed on a scale, or a pot that holds a fluid heated by an immersion circulator or an induction cooker, such as that disclosed in International Patent Application No. PCT/AU2011/000887, filed 15 Jul. 2011, which is herein incorporated by reference in its entirety).

Each cooking appliance 110 can execute cooking programs, comprising computer program instructions executable by a processor of the cooking appliance 110, the user device 120, or both, and causing the cooking appliance 110 to perform at least a portion of a process for cooking food. The cooking appliance 110 can communicate directly or indirectly with other cooking appliances 110, the user device 120, or the appliance management server 130. For example, the cooking appliance 110 can send a measurement captured by the appliance 110, such as a weight of food, to the user device 120, which can in turn send the appliance 110 instructions to perform an action based on the measurement. While executing a cooking program, the cooking appliance 110 can also communicate with other appliances to transmit and receive information about the cooking program. For example, the cooking appliance 110A can transmit information to the cooking appliance 110B about a cooking program being executed by the appliance 110A to cause the appliance 110B to change a setting.

In various embodiments, the cooking appliance 110 can include user input devices, user output devices, or both. Exemplary output devices include a user interface that displays information to a user or a speaker that plays alert sounds or synthesized speech to communicate information to a user. In some cases, the user interface can additionally receive user inputs, for example, to apply a setting to the cooking appliance 110.

The user device 120 is a computing device used by a user, such as a mobile phone, wearable computer (e.g., a watch), tablet, laptop or desktop computer. In another embodiment, the user device 120 comprises a smart router, hub, or another integration device (e.g., including devices similar in functionality to the Amazon Alexa™ smart hub). The user device 120 can wirelessly communicate with the cooking appliances 110 to control settings of the appliances. In some embodiments, the user device 120 facilitates communication between cooking appliances, such as transmitting information from the cooking appliance 110A to the cooking appliance 110B. The user device 120 can also communicate with the appliance management server 130. For example, the user device 120 receives recipes from the appliance management server 130 and causes the cooking appliance 110 to execute at least a portion of a recipe.

The user device 120 can execute a program or application that provides instructions, data, or both to the cooking appliance 110 and receives information from the appliance 110 via one or more suitable communications interfaces (e.g., Bluetooth, Bluetooth Low Energy, USB, or Wi-Fi). The application can prompt a user to enter information related to food, recipe, or cooking process, such as a size, shape, or class of a food item or ingredient, an altitude or geographic location where the user is located, or preferences of the user with respect to, for example, ingredients used in food or ending characteristics of the food.

Additionally, a user can use the user device 120 to experience (e.g., view or listen to) audio/image/video (“media”) depictions of a prepared food product. The media depictions can present media depictions of the prepared food product at various gradations or variants of an ending characteristic, such as texture, taste-sensation, consistency, or doneness. The media depictions allow the user to select a preferred gradation for one or more characteristics of a cooked food product, such as the texture, consistency, color, or any other still or moving visual indication of a desired result for a food product (e.g., egg yolk, egg white, steak) based on visual image, pictorial, or video representations of the food product at a variety of different gradations. The user selection can be used to generate commands to cause the cooking appliance 110 to cook food that will have the selected ending characteristic. After cooking food, the user can use the device 120 to provide information about resulting conditions of the food to improve the commands to the cooking appliance 110. For example, the user device 120 can prompt the user to select a media depiction illustrating an actual result of the cooked food product. The user device 120 can alternatively provide a list of food results the user can select between, such as “burned,” “undercooked,” “overcooked,” “chewy,” “tender,”, “firm”, “succulent”, “crispy”, “fall-apart” or others.

The appliance management server 130 maintains recipes for food and facilitates interactions between the cooking appliances 110 and user device(s) 120. In an embodiment, the appliance management server 130 can store no personally identifiable information, but can maintain data structures including demographic information for users of the cooking appliances 110, user profiles and favorites, or national and regional trend data including trends in popular recipes or information about food items that are associated with a season in a given region (e.g. recipes for cooking crawfish during crawfish season in the southeastern United States).

Each recipe stored by the appliance management server 130 can define a process for cooking a food item, including amounts of one or more ingredients in the food. An ingredient can be a homogenous or heterogeneous substance and can be raw, partially cooked, or cooked. For example, various recipes can include ingredients such as water, salt, precooked and chilled rice, or crumbs made from baked cookies. Each recipe can also include information about parameters for cooking the food, such as temperature to be output by the cooking appliance 110 and an amount of time to cook the food. Some recipes may further include instructions for performing specified actions while food is being prepared, such as stirring the food, adding an ingredient at a specified rate, leaving a lid on the container for a specified length of time, changing an attachment, lid and or accessory such as that used for a multi-cooker in the form of a kitchen device as disclosed in International Patent Application No. PCT/AU2019/050681, filed 28 Jun. 2019, which is herein incorporated by reference in its entirety. At least a portion of each recipe can be provided as a cooking program, including computer program instructions that are executable by the cooking appliance 110. The cooking program can include instructions that cause the cooking appliance 110 to perform an action, such as apply a setting, or cause the cooking appliance 110 to output instructions to a user or to other cooking appliances 110.

The appliance management server 130 can also provide a social network through which users or cooking appliances 110 can communicate. Each user or appliance can be represented by a node in the social network and can connect to one or more other nodes through the appliance management server 130. The server 130 generates an interface for the social network that allows users or appliances to post messages, status reports, pictures, recipes, videos or other information, and to allow users to view and interact with information posted by the appliances or other users. The appliance 110 can transmit messages to the social network that describe recipes it is executing or the appliance's status. For example, an appliance 110 registered to a user Fred may post the message “Fred's pot roast is ready!” to the social network when the appliance finishes cooking a recipe entitled “Pot Roast.” Users can create profiles in the social network and connect to other users to exchange recipes, share cooking tips, or view statuses of the appliances 110.

In some cases, the appliance management server 130 can automatically connect a user to one or more other users in the social network based on determined similarities in the users' cooking characteristics, geographic region, recipe preferences or other criteria. For each user, the appliance management server 130 can maintain a data structure identifying any recipes the user has cooked and information such as the number of times the user cooked each recipe, any feedback the user provided about the recipe, the number of servings of the recipe the user prepared, or modifications the user made to the ingredients or steps in the recipe. The data structure can also identify characteristics such as the type(s) of cooking appliances 110 the user uses, the frequency at which the corresponding user uses the cooking appliance 110, menus or groups of food items cooked by the user, or the number of servings the user prepares each time the appliance 110 is used. The management server 130 can apply any of a variety of statistical or machine learning techniques to the data structures to identify or cluster similar users. For example, the management server 130 calculates a Jaccard index for pairs of users, representing the number of recipes that both users cooked in a specified amount of time (e.g., the past year) as a proportion of the total number of recipes the two users cooked in the same amount of time. If the Jaccard index for the two users is greater than a threshold (such as 0.2), the management server 130 recommends the users connect with one another through the social network. Alternatively, the appliance management server 130 can apply a neural network to the user data structures to extract pairs of similar users and recommend connections between the users. The appliance management server 130 can also allow users to manually connect to other users in the social network. For example, the management server 130 provides a search function for users to search for other users by name, recipe, or cooking characteristics.

The appliance management server 130 can also integrate support functionality into the social network. The support functionality can assist users with cooking appliances 110 or recipes. Professional or celebrity chefs, for example, can support users with developing or modifying recipes. Customer service can support users if problems arise with the cooking appliances 110.

An exemplary social feed 150 generated by the appliance management server 130 is shown in FIG. 1B. The social feed 150 can be displayed to a target user by the user device 120 and can include information posted by or about other users the target user is following or to whom the target user is connected through the social networking system. As shown in FIG. 1B, the social feed 150 can include posts generated by cooking appliances 110, such as the post 152 generated by a pressure cooker. An appliance 110 posting information to the social feed 150 can in some embodiments tag another user, such as a user to whom the appliance 110 is registered. Posts can also be generated by human users of the server 130, as shown for example by the posts 154 and 156. Users can share recipes with each other, as illustrated by the post 158. In some embodiments, the appliance management server 130 can also integrate professional or celebrity chefs and customer support into the social network. The post 160, for example, illustrates that a chef can respond to user queries. The post 162 illustrates that customer support can communicate with users through the social feed 150. In one form, the appliance management server 130 can have stored in memory one or more bots (also referred to by those skilled in the art as an Internet bot or a web robot) which are configured to automatically respond to questions from one or more users with extra information or takes action when mentioned in comments on a post. Each bot is a software application hosted and executed by the appliance management server 130 to automatically perform a task without human intervention. In one form, at least some of the one or more bots can converse with people in a chat application presented via the user device 130, providing information in real time, or handling requests with structured conversation elements like quick replies and persistent menus. In one form, the social feed 150 generated by the appliance management server 130 for a target user can include one or more posts which are automatically generated by the one or more bots.

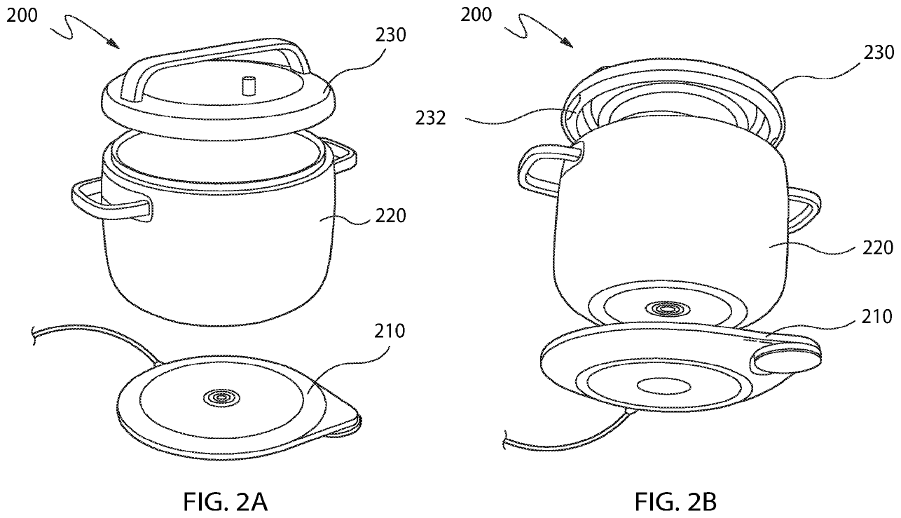

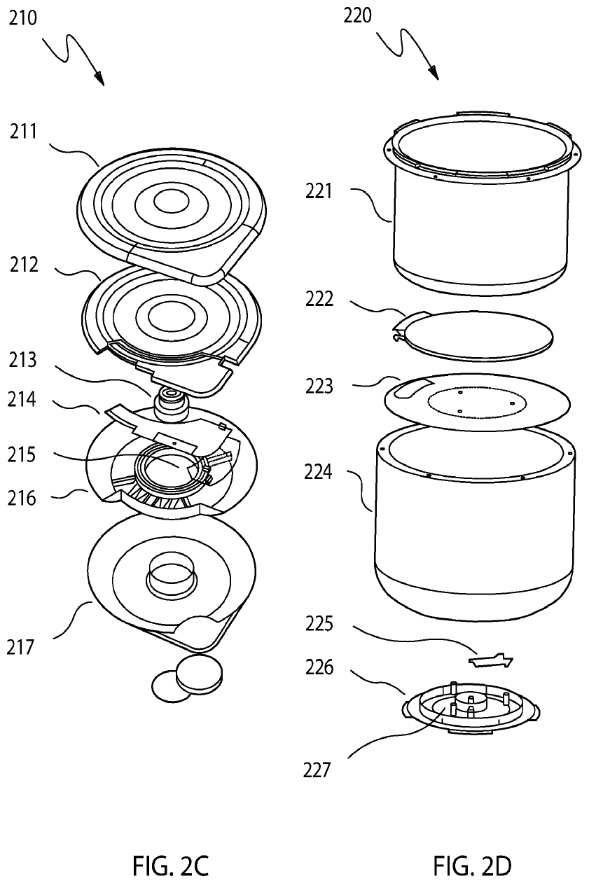

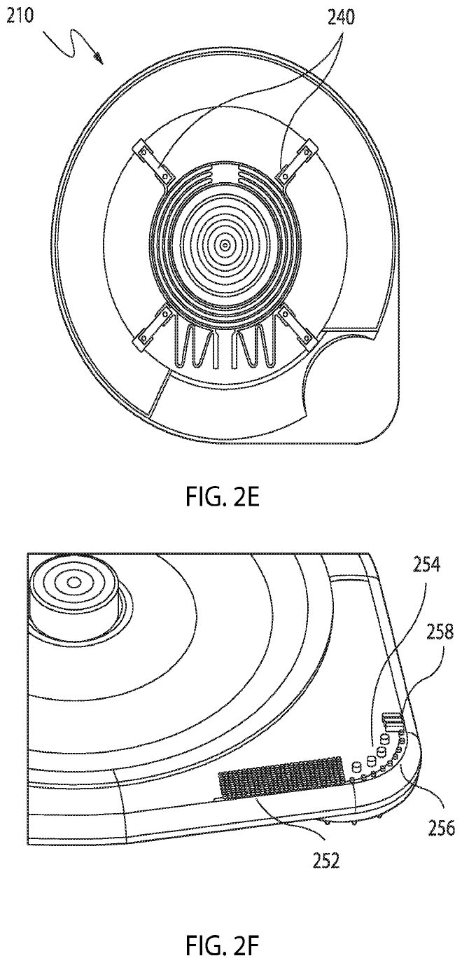

FIGS. 2A-2F illustrate one exemplary cooking appliance 110. In the example of FIGS. 2A-2F, the cooking appliance 110 is a multicooker or a pressure cooker 200. The pressure cooker 200 can include a base 210, a pot 220, and a lid 230. The base 210 can electronically couple to a heating element in the pot 220 to heat food held in the pot 220. The lid 230 can secure to a top of the pot 220. The lid 230 can optionally include a seal 232 that seals around the top of the pot 220, allowing pressurization of an interior of the pot.

FIG. 2C is an exploded view of components of the base 210. As shown in FIG. 2C, the base 210 can include a top enclosure 211, a top heat sink 212, a base connector 213, a control board 214, a power board 215, a bottom heat sink 216, and a bottom enclosure 217. The top and bottom enclosures 211, 217 together can at least partially enclose components of the base 210. In some embodiments, the top and bottom enclosures 211, 217 when coupled can form a watertight seal to prevent intrusion of water into electrical components of the base 210. The top and bottom heat sinks 212, 216 each can comprise a material with a relatively high specific heat, enabling the heat sinks 212, 216 to capture heat produced by the pressure cooker 200 and reduce heat transfer to electrical components of the base 210.

The control board 214 comprises electronics for controlling outputs by the pressure cooker 200. In some embodiments, the control board 214 includes one or more processors and a memory. The one or more processors can execute instructions stored in the memory, as well as write information to the memory. The control board 214 can also include communications circuitry enabling the pressure cooker 200 to communicate with external devices by wired or wireless communication. The control board 214 can further include or couple to input and/or output devices, such as a display, a microphone, a speaker, one or more buttons, or other devices that enable a user to input information to or receive information from the pressure cooker 200.

The power board 215 can receive electrical power, for example from a power grid, and regulate power supplied to the various electrical components of the pressure cooker 200. The base connector 213 can couple to the power board 215 and the pressure cooker pot 220 to supply power to components of the pot 220.

The pressure cooker 200 can include components other than those shown in FIG. 2C. For example, the pressure cooker 200 can include a camera positioned to capture image data of the cooker pot 220 to monitor a fill level within the pot. Alternatively, the control board 214 can receive image data from an external camera, such as a camera in the user device 120.

FIG. 2D is an exploded view of components of the pressure cooker pot 220. As shown in FIG. 2D, the pot 220 can include an inner pot 221, a heater 222, a heat shield 223, an outer pot 224, a printed circuit board assembly (PCBA) 225, and a bottom cover 226 with electrical connector 227. The inner pot 221 holds food while the food is cooking. In some embodiments, a bottom and side walls of the inner pot 221 comprise a thermally conductive material. The heater 222 can make contact with and apply heat to the inner pot 221. The inner pot 221 transfers the heat to the food contained in the inner pot to cook the food. The heater 222 can be an electric heater, and an amount of heat produced by the heater 222 can be adjusted by regulating an amount of electric power input to the heater 222. The heat shield 223 separates the heater 222 from electrical components of the pressure cooker 200 to thermally isolate the electrical components from the heater 222. The inner pot 221, heater 222, and heat shield 223 can be at least partially contained within the outer pot 224. The outer pot 224 can comprise an insulating material that reduces heat transfer from the heater 222 and inner pot 221 to an exterior of the pressure cooker 200.

The PCBA 225 comprises circuitry to control outputs by the pressure cooker 200. For example, the PCBA 225 comprises a control circuit to regulate heat output by the heater 222. The electrical connector 227 couples to the base 210 and to the PCBA 225 and heater 222 to supply electrical power from the base 210 to the electronic components of the pot 220. The bottom cover 226 attaches to a bottom of the outer pot 224 and can support the PCBA 225 and electrical connector 227.

FIG. 2E is a top view of one embodiment of the pressure cooker base 210. As shown in FIG. 2E, the base 210 can include multiple load cells 240. The load cells 240 can measure weights of items (such as food item) placed on the base 210. The control board 214 can be coupled to the load cells 240 to receive the weight measurements. The base 210 can, therefore, function as a scale, measuring weights of the food placed in the pot 220. In some embodiments, the multiple load cells 240 are distributed around a central axis of the base 210, enabling the base 210 to detect not only a total amount of weight placed on the base 210 but also a distribution of the weight.

FIG. 2F illustrates that various display elements can be integrated into the base 210. In some embodiments, the base 210 can include an LED array 252, a set of icon LEDs 254, a set of gauge LEDs 256, and a set of pressure LEDs 258. The LED array 252 includes LEDs arranged in an array (e.g., 5×30 rectangular array) that can be turned on or off to collectively display words or numbers. The icon LEDs 254 can display information about settings or modes applied at the pressure cooker 200. For example, each icon LED 254 can correspond to a particular mode or setting, such as whether the pressure cooker is powered on, whether food is actively cooking or is being held at a low temperature, or other modes or settings that can have binary active/inactive settings. The corresponding icon LED 254 can be illuminated if the mode or setting is active and turned off if the mode or setting is inactive. Alternatively, the icon LEDs 254 can identify a setting whose value is indicated by the gauge LEDs.

The gauge LEDs 256 can indicate settings that have a range, and the LEDs in the set can be consecutively illuminated as the value of the setting increases within the range. For example, the gauge LEDs 256 can indicate a temperature output by the pressure cooker 200. A single gauge LED 256 can be illuminated when the pressure cooker 200 is set to output its lowest heat setting, and the LEDs 256 can be sequentially illuminated as the temperature increases until all LEDs in the set 256 are illuminated. The gauge LEDs 256 can similarly be sequentially illuminated to indicate fill level of the pot 220 or other settings that can fall within a range of possible values. The fill level of the pot 220 can be detected based on image data captured by a camera directed toward the pot 220, based on the weight of the pot, based on sensors (such as light or resistance sensors) placed at varying heights throughout the pot 220, or based on other techniques. In some embodiments, the value of the setting shown by the gauge LEDs 256 can be switched, allowing the user to iterate for example between viewing information about the temperature output, the fill level of the pot, or other settings. The setting shown by the gauge LEDs 256 can be indicated by the icon LEDs 254.

The pressure LEDs 258 can indicate an amount of pressure in the pot 220. Like the gauge LEDs 256, the pressure LEDs 258 can be sequentially illuminated as the pressure in the pot 220 increases. Other display devices can be included in the base 210 instead of or in addition to the LED sets. For example, the base 210 can include an OLED or LCD display screen.

Various embodiments of a pressure cooker that can be used as the cooking appliance 110 are described further in U.S. Provisional Patent Application No. 62/798,973, filed 30 Jan. 2019, which is incorporated herein by reference in its entirety.

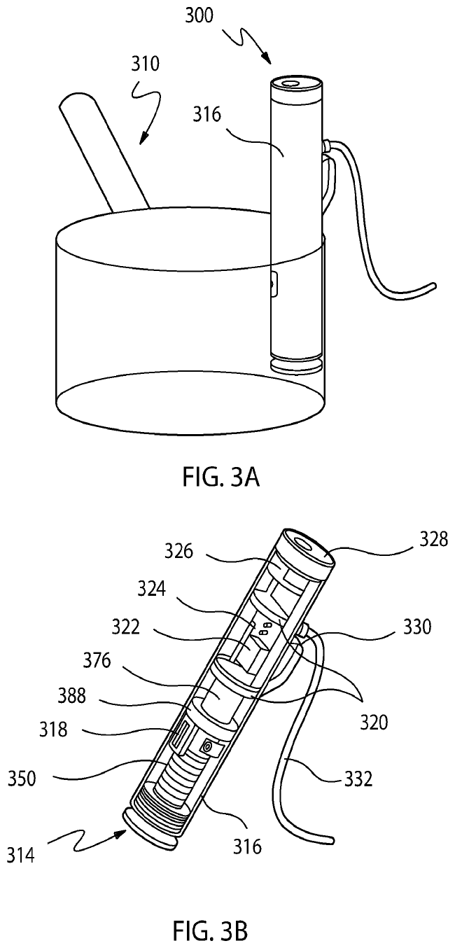

FIG. 3A-3B illustrate another example cooking appliance 110. In the example of FIGS. 3A-3B, the cooking appliance 110 is an immersion circulator used to perform sous vide cooking. Sous vide is a method of cooking food in a water bath or in a temperature-controlled steam environment for longer than normal cooking times at an accurately regulated temperature much lower than normally used for conventional cooking. In some instances, the food is sealed (e.g., watertight, airtight) in plastic bags. Sous vide cooking techniques typically employ temperatures around 55° C. to 80° C. for meats and higher for vegetables. The intention is to cook the item evenly, ensuring that the inside is properly cooked without overcooking the outside, and retain moisture.

As shown in FIG. 3A, an example immersion circulator 300 can be positioned on a cooking container 310. The container 310 can hold a body of water or another fluid for cooking food, and the immersion circulator 300 can be used to heat up, maintain a temperature of, or circulate the fluid within the container 310. The immersion circulator 300 can be positioned to stand upright in the container 310 on a bottom end of the circulator 300 or can be clipped, clamped, or otherwise attached to a rim or side of the container 310. In some embodiments, a position of the circulator 310 in the container can be adjusted based on the size of the container 310, depth of fluid in the container, or other factors. The immersion circulator 300 can include a waterproof housing 316 that protects internal circuitry while the circulator 300 is submerged in the fluid.

FIG. 3B illustrates that the thermal immersion circulator 300 can include a top cap assembly 328 coupled to the housing 316 to cap a top end of the housing. A power cord 332 is electronically coupled to electronic components of the immersion circulator 300 and can be used to plug the circulator 300 into a standard wall socket to draw power from a power grid. A removable clip 330 can be positioned on a side of the housing 316. The clip 330 can be used to clip the circulator 300 to the side of the container 310, such as to mount the circulator 300 in a position on the container 310 such that a bottom end of the circulator 300 is submerged in the fluid in the container and the power cord 332 is not submerged. The clip 330 can be used to clip the immersion circulator 310 to containers of various sizes and shapes, such as pots having various radii of curvature. Furthermore, the circulator 300 can have attachment mechanisms other than the clip 300 to releasably couple the immersion circulator 300 to the container 310, such as a clamp, a magnet, or a screw.

Internal components of one embodiment of the immersion circulator 300 are also shown in FIG. 3B. As shown in FIG. 3B, the immersion circulator 300 can include a lower inlet assembly 314 having a flat bottom surface on which the circulator 300 can stand, such as in the container 310. In some implementations, the flat bottom surface can include a magnet to help maintain the position of the circulator 300 within the container 310. The lower inlet assembly 314 can have a peripheral, radial opening through which a fluid can be drawn into, or through which a fluid can be expelled from, an interior of the circulator 310. The housing 316 can also include an opening 318 in a side wall of the housing 316, through which a fluid can be drawn into or expelled from the interior of the circulator 310.

Within the housing 316 is a heater 350. A bottom end of the heater 350 can be coupled to the lower inlet assembly 314 so that an internal conduit or passage through the heater 350 is in fluid communication with the peripheral opening of the inlet assembly 314. A side surface of the heater 350 can also be coupled to the opening 318. Alternatively, the internal conduit through the heater 350 can be in fluid communication with the opening 318. A motor 376, supported by a motor mount 388, can drive an impeller (not shown) to drive fluid through the internal conduit of the heater 350.

The thermal immersion circulator 300 can include upper and lower thermal isolation barriers 320, which can separate the circulator 300 into distinct thermal regions or chambers. For example, the thermal isolation barriers 320 can isolate an electronics module housing 326 from the heater 350. Mounted within the electronics module housing 326 can be a high-temperature transformer 322 and a printed circuit board assembly 324.

Various embodiments of a thermal immersion circulator 300 that can be used as the cooking appliance 110 are described further in U.S. patent application Ser. No. 16/093,612, filed Oct. 12, 2018, which is incorporated herein by reference in its entirety.

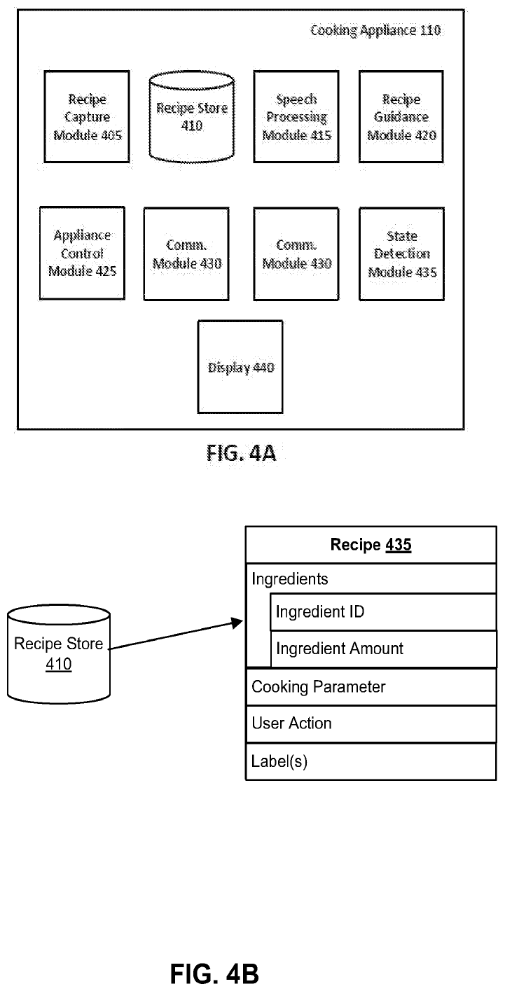

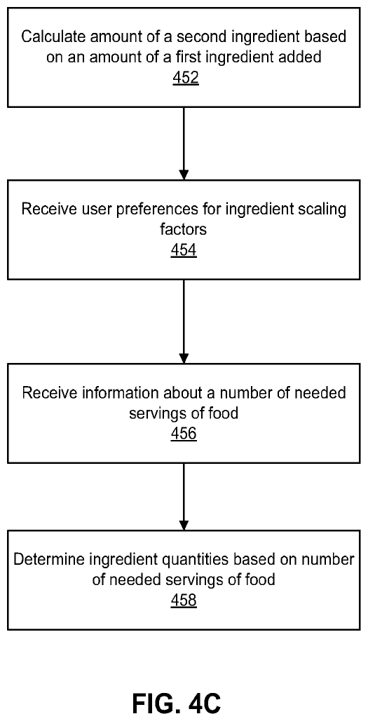

FIG. 4A is a block diagram illustrating functional modules executed by the cooking appliance 110. As shown in FIG. 4A, the cooking appliance 110 can execute a recipe capture module 405, a recipe store 410, a speech processing module 415, a recipe guidance module 420, appliance control module 425 a communications module 430, a state detection module 435, and a display module 440. Each of the modules can include computer program code executable by a processor of the cooking appliance 110. Alternatively, the modules can be hardware modules, such as ASICs, or a combination of software and hardware. Other embodiments of the cooking appliance 110 can execute additional, fewer, or different modules than shown in FIG. 4A, and functionality can be distributed differently among the modules. Furthermore, some functions can be performed in some embodiments by devices other than the cooking appliance 110, such as the user device 120 or the appliance management server 130.

The recipe capture module 405 captures elements of a recipe while a user uses the cooking appliance 110. Based on the captured elements, the recipe capture module 405 generates a recipe and stores the recipe in the recipe store 410. A logical representation of a recipe 450 is shown in FIG. 4B.

Recipe elements captured by the recipe capture module 405 can include amounts of ingredients the user adds to food. The ingredient amounts can be measured as weight or volume of each ingredient, as a dimension, or as against some external criteria (e.g., measurement of a liquid as compared to a fill line of a vessel). In some embodiments, the recipe capture module 405 captures an ingredient weight based on weights measured by a scale associated with the cooking appliance 110. For example, the recipe capture module 405 receives a weight of the container measured by the scale both before and after the user adds an ingredient to the container. The ingredient weight can then be calculated by subtracting a total weight of the container and its contents before the user added the ingredient from the total weight after the user added the ingredient. In other embodiments, the recipe capture module 405 receives a measurement of dimensions of the ingredient. The user can, for example, manually enter the dimensions into the cooking appliance 110 or user device 120, or the user device 120 can calculate the dimensions from a picture of the ingredient (e.g. a photo taken by the user device of the food item is utilized by an algorithm running on the user device to geometrically calculate a volume or dimension of the food item). The recipe capture module 405 can receive an identifier of each ingredient as it is added to the food and store the ingredient amount in association with the received identifier. The identifier may identify a specific ingredient (e.g., Basmati rice), a classification for an ingredient (e.g., white rice), packaging that contained the ingredient (e.g., a 5 oz. bag of white Basmati rice) and/or a specific brand of ingredient (e.g., Uncle Ben's™ white Basmati rice).

Other recipe elements captured by the recipe capture module 405 can include a parameter for cooking the food. As an example, the parameter comprises a temperature output by a heating element of the cooking appliance 110 or an amount of time the food cooks. The parameter can represent an output from the cooking appliance 110, e.g., resulting from a setting the user applies to the appliance 110. In some cases, the recipe capture module 405 receives the parameter from a setting the user enters into the cooking appliance 110 while preparing the food (e.g., by interacting with a user interface on the appliance or speaking a command that is captured by a microphone on the appliance 110). In other cases, the recipe capture module 405 receives the setting from the user device 120.

Still other recipe elements that can be captured by the recipe capture module 405 include actions performed by the user while the user is cooking food. The action can include, for example, a time the user stirs the food or a rate at which the user pours an ingredient into the container. Each action can be captured as occurring at a particular time relative to other actions in the cooking process, such as after or before certain ingredients have been added, after the food has remained untouched (e.g., in a closed pot) for a determined amount of time, or at other determinable points in the cooking process.

A recipe can also include one or more labels that can be used to uniquely identify and/or classify the recipe. One example label is a recipe identifier uniquely identifying the recipe (such as a unique title or alphanumeric identifier). Another label can be a source identifier, associating the recipe with an individual or entity who created or uploaded the recipe, or a brand or trade name affiliated with the recipe (e.g., Michael Jordan's Jumpin' Wings recipe). Other labels can identify a geographic or regional origin or association of a recipe (e.g., Thai curry or Irish curry). Still other labels can classify ingredients, including for example identifiers of the ingredients (e.g., UPC information), brand names affiliated with the ingredients, geographic origin of the ingredients (e.g., coffee from Kenya or from Central America), supply chain information for the ingredients, or information about when each ingredient is in season in a particular geographic region.

The recipe capture module 405 generates a recipe based on the captured elements. An exemplary recipe data structure 450 is shown in FIG. 4B. As shown, a recipe 450 can include identifiers of ingredients that were added, an amount of each ingredient, at least one cooking parameter corresponding to a setting applied to the cooking appliance 110, one or more actions performed by the user while preparing the food, and/or any labels applied to the recipe. Any of a variety of recipe formats can be generated by the recipe capture module 405. Some recipes, for example, can include a simplified list of ingredients used in the recipe and a temperature for cooking the food. Other recipes can be generated (and depicted) as a timeline, in which the elements of the recipe are tagged with times at which the user performed each step and the elements are presented as an ordered list.

In some embodiments, the recipe capture module 405 simplifies a recipe by aggregating steps performed by the user. For example, if a user adds a small amount of a first ingredient several times while cooking the food, the recipe capture module 405 aggregates the amounts to determine a total amount of the first ingredient that was used. As another example, if the user changed the temperature output by the cooking appliance 110 multiple times while cooking, the recipe capture module 405 can select one of the temperatures (such as the last temperature setting) or calculate a temperature for the recipe (such as a mean of the temperatures set by the user).

After generating a recipe, the recipe capture module 405 can provide the recipe for review by the user. For example, the recipe capture module 405 can send the recipe to the user device 120 for display to the user. The user can interact with the user device 120 to make any desired changes, such as increasing or decreasing ingredient quantities, increasing or decreasing time or temperature parameters, changing the order of steps in the recipe, or adding or removing actions from the recipe.

The recipe store 410 stores at least a portion of one or more recipes, including any media associated with the recipe. As the recipe capture module 405 captures elements of a recipe, the elements can be written to the recipe store 410 to generate the recipe. Recipes can additionally, or alternatively, be downloaded to the cooking appliance 110 and stored in the recipe store 410. For example, the cooking appliance 110 can receive recipes from the appliance management server 130 that were created by users of other appliances.

The speech processing module 415 detects and processes voice inputs to the cooking appliance 110. The speech processing module 415 can be coupled to a voice input device, such as a microphone. If a voice input is detected at the voice input device, the speech processing module 415 analyzes the voice input for a command. For example, the speech processing module 415 can extract the command “Turn Off” from the voice input. Based on the command, the speech processing module 415 causes the appliance 110 to turn off a heating element. Other commands can include increasing or decreasing a temperature of the heating element or starting or stopping a cooking program. Voice inputs can additionally or alternatively be analyzed to identify ingredients added to food. For example, the speech processing module 415 can extract “onion” from a speech input and determine that onion is an identifier of an ingredient added during preparation of a food item. Other voice inputs can be analyzed to change a display of the cooking appliance 110. For example, if a voice input is received while the cooking appliance 110 is displaying a first datum or type of information (such as a temperature setting), the speech processing module 415 can process the voice input and cause the cooking appliance 110 to display a second datum (such as a cook time) in response. Indeed, a user may use speech input to the speech processing module 415 to perform any data inputs noted herein.

The recipe guidance module 420 guides a user to cook food using a recipe. When a user selects a recipe to cook, the recipe guidance module 420 extracts cooking steps from the recipe. Based at least in part on the cooking steps, the recipe guidance module 420 generates instructions that cause the cooking appliance 110 or another device to perform steps in the recipe, or that instruct a user to perform actions related to the recipe. Although FIG. 4A shows that the recipe guidance module 420 is executed by the cooking appliance 110, the module 420 can instead be executed by the user device 120, the appliance management server 130, or two or more of the appliance 110, user device 120, or appliance management server 130.

In some embodiments, the recipe guidance module 420 guides the user to add specified quantities of ingredients to food. An example process performed by the recipe guidance module 420 to guide the user in adding ingredients is shown in FIG. 4C. A recipe can implicitly or explicitly indicate relative quantities of multiple ingredients. For example, a recipe can call for two ounces of sugar and one ounce of salt, implying a sugar to salt ratio of 2:1. Another recipe can explicitly specify a 2:1 ratio of sugar to salt. If, when cooking food, a user adds more or less than the amount of a first ingredient called for by a recipe, the recipe guidance module 420 calculates at block 452 an amount of a second ingredient that should be used based on the amount of the first ingredient, and instructs the user to add the calculated amount to the food. For example, if the user adds four ounces of sugar to the cooking container when the recipe called for two ounces, the recipe guidance module 420 can notify the user and can instruct the user to similarly double the amount of salt in the dish. Similarly, if the user adds 10% less sugar than called for by the recipe, the recipe guidance module 420 calculates a proportionally-reduced amount of salt and instructs the user to add the calculated amount of salt.

When guiding a user to add specified quantities of ingredients to food, the recipe guidance module 420 can calculate the amount of each ingredient by scaling the quantity of each ingredient linearly or non-linearly. In some cases, a recipe can include scaling factors indicating how ingredients should be scaled. Some scaling factors can indicate a binary determination of whether a second ingredient should be scaled relative to a first ingredient. For example, if the absolute amount of a second ingredient is more important to the outcome of food than the amount relative to a first ingredient, a scaling factor in the recipe can indicate that the amount of the second ingredient should not be changed if the amount of the first ingredient changes. Other scaling factors can specify relative proportions between changes in amounts of a first ingredient and amounts of a second ingredient. These relative proportions can be a linear function, an exponential function, a stepwise function, or another type of function. For example, one scaling factor can indicate that one ingredient should be increased or decreased by 75% of any increases or decreases in another ingredient. Another scaling factor can indicate that a first amount of a first ingredient should be used if the amount of a second ingredient is in the range of X ounces to Y ounces, a second amount of the first ingredient should be used if the second ingredient is in the range of Y ounces to Z ounces, and a third amount should be used if there is more than Z ounces of the second ingredient in the food. Some scaling factors can be positive (e.g., causing the recipe guidance module 420 to instruct a user to increase the amount of the second ingredient if the amount of the first ingredient increases), while other scaling factors can be negative (e.g., causing the recipe guidance module 420 to instruct a user to decrease the amount of the second ingredient if the amount of the first ingredient increases). For example, causing the recipe guidance module 420 to instruct a user to increase the amount of sugar and reduce the amount of honey.

In some embodiments, the recipe guidance module 420 can receive, at block 454, preferences set by a user for the ingredient scaling factors used by the recipe guidance module 420. These preferences can identify certain ingredients or certain types of ingredients whose quantities can be changed independently of other ingredients, such that a change in their quantities are not used as the basis for changing quantities of other ingredients. For example, a user who prefers spicier food may desire to add greater quantities of spicy ingredients to the food without changing other ingredient ratios. The user can, therefore, set a preference that causes the recipe guidance module 420 to not increase quantities of other ingredients if the user adds more hot sauce, habanero peppers, or dried cayenne pepper to the cooking container. A user who is cooking a meal for a person on a low-sodium diet may set a preference that causes the recipe guidance module 420 to not decrease ingredient quantities if the user uses less salt in food.

In some embodiments, the recipe guidance module 420 instructs a user to change quantities of ingredients in order to scale up or scale down a total quantity of the food that will be produced. To recommend a quantity of the food, the recipe guidance module 420 can receive, at block 456, information about a number of servings of the food that are needed and determine, at block 458, a quantity of each ingredient appropriate for the number of servings. In some cases, a recipe can indicate particular amounts of ingredients that will produce a specified number of servings of the food. These amounts can be preset by the creator of the recipe, learned based on eating patterns of the user of the cooking appliance 110, or learned based on eating patterns of multiple users. The recipe guidance module 420 can calculate and generate recommended ingredient amounts by scaling the ingredient amounts in the recipe in proportion to the ratio between the number of servings in the recipe and the number of servings needed by the user.

In some cases, the user can explicitly indicate the number of servings of food that the user desires to cook. For example, the user can input the desired number of servings into the user device 120, which can transmit the user input to the recipe guidance module 420 to calculate the ingredient amounts. Additionally or alternatively, the recipe guidance module 420 can receive or determine eating patterns of a user. These eating patterns, generated, for example, based on habits of a user over specified periods of time or with respect to particular events, can represent an expected amount of food that the user will cook on a given day. Each time a user uses the cooking appliance 110, the recipe guidance module 420 stores data indicating the amount of food the user cooked. The stored data can be analyzed using any of a variety of statistical or machine learning techniques, such as regression, classification, clustering, ARIMA (Autoregssive integrated moving average), neural networks, K-means clustering, or principal component analysis, to identify correlations between the amount of food cooked and characteristics of the day the food was cooked. Exemplary day characteristics include the day of the week, day of the month, or events on a calendar such as holidays or meetings. For example, a user may often prepare food for three days on Monday. From the user's cooking habits, the recipe guidance module 420 extracts a pattern indicating that the user has a probability above a specified threshold of cooking three servings of food on a Monday. Another user may have “Monthly dinner with Mom, Dad, and Joe” as an event on her calendar recurring once each month. Based on the amount of food the user cooked on the day of the event each month, the recipe guidance module 420 can extract a pattern indicating that the user has a high probability of cooking four servings of food on any day on which the recurring event is scheduled. Yet another user may cook dinner for his roommate on Tuesday nights and his ten-year-old cousin on Friday nights. Because the user cooks more food for his perpetually-hungry roommate than for his young cousin, the recipe guidance module 420 can extract a pattern indicating that the user has a high probability of cooking 2.5 servings of food on Tuesday nights and 1.7 servings of food on Friday nights.

Based on either the manually-input number of servings or the expected amount of food the user is likely to cook, the recipe guidance module 420 generates a recommendation to increase or decrease amounts of ingredients the user uses while preparing food. For example, after the user adds a first amount of an ingredient in a recipe for a food item, the recipe guidance module 420 can recommend the user increase the ingredient to a second amount in order to prepare one or more additional servings of the food.

In some embodiments, the recipe guidance module 420 generates instructions that guide a user to add ingredients to the cooking container according to a specified process. This process can be specified by a recipe, and can include an order in which ingredients are added to the container, a rate at which each ingredient is added, or actions taken by a user while preparing food. For example, after the user adds a first ingredient to the container, the recipe guidance module 420 generates an instruction to add a second ingredient to the container. The second ingredient is selected based on an order of the ingredients specified in the recipe. As another example, the recipe guidance module 420 generates an instruction to pour an ingredient into the container faster or slower. The recipe guidance module 420 can retrieve a rate from the recipe and determine a rate at which the user is adding the ingredient based on a rate of change of the weight measured by the scale. If the rate at which the user is pouring the ingredient into the container is higher, for example, than the rate in the recipe, the recipe guidance module 420 can instruct the user to pour the ingredient more slowly.

In some embodiments, the recipe guidance module 420 generates instructions that guide a user to perform actions related to cooking the food. For example, the recipe guidance module 420 instructs the user to stir the ingredients in the cooking container if the ingredients have not been stirred in at least a specified amount of time. If ingredients need to be added at certain times during the cooking process, the recipe guidance module 420 can determine the times to add an ingredient and instruct the user accordingly.

Instructions generated by the recipe guidance module 420 can also include instructions that cause other cooking appliances 110 to perform an action related to cooking food. These actions can include, for example, increasing or decreasing a set point temperature or increasing or decreasing an amount of cook time set at the other appliances. Other actions can include operating an oven (e.g. turning on the broiler), turning on a fan/range hood, adjusting the temperature of a refrigerator/freezer, controlling a range fan, sounding one or more audible alarms, controlling audible or visual operations within a smart hub, etc.

The state detection module 435 detects physical states of the cooking appliance 110. The physical state of the appliance 110 can include the presence or absence of a particular item, a relative amount of an item associated with the appliance 110 that is coupled to or placed on or in the appliance 110, or a property of an item associated with the appliance 110. In some embodiments, the state detection module 435 receives a weight signal from the load cells 240 and determines the physical state based on the measured weight. In other cases, the state detection module 435 receives an electrical signal from a component that is electrically coupled to the appliance 110, where the electrical signal identifies the component to the state detection module 435. In still other cases, the state detection module 435 can detect a parameter of the cooking appliance 110 that is indicative of the presence of a particular item or amount of an item.

For example, the state detection module 435 can detect that the pot 220 has been placed on the base 210 in response to detecting a weight increase measured by the load cells 240. If the weight increase is detected, the state detection module 435 can, in some cases, set a flag or output a Boolean value indicating that the pot 220 is present. In some cases, the pot placed on the base 210 may be one of several possible pots that each have a different weight. When the state detection module 435 receives a signal from the load cells 240 indicating a measured weight increase, the state detection module 435 can access a table that matches identifiers of pots to their approximate weights. By comparing the received weight increase to the approximate weights in the table, the state detection module 435 selects a pot identifier that is mapped to an approximate weight that most closely matches the measured weight. The state detection module 435 can output the selected identifier as the identifier of the pot that was placed on the base.

In another example, the state detection module 435 detects that a pot 220 has been placed on the base 210 in response to detecting an electrical signal from the pot. For example, the state detection module 435 receives a signal when the electrical connector 227 of the pot 220 is electrically coupled to the base connector 213, indicating that the pot 220 has been placed on the base 210. In some cases, the pot PCBA 225 can transfer information to the state detection module 435 over the electrical connector 227, such as an identifier of the pot 220 that was placed on the base, thereby allowing the system to automatically determine which of several different pots has been placed on the base, and other parameters of the pot such as its fluid volume, thermal characteristics, etc.

The state detection module 435 can also detect whether a pot lid is open or closed. In some cases, the pot lid is separable from the pot, as shown for example in FIG. 2A. When the pot lid is separable, the state detection module 435 can detect whether the lid is present based on a weight measurement received from the load cells 240. For example, if a weight increase is detected after the pot and its contents have been placed on the base 210, the state detection module 435 can determine that the lid has been placed on the pot. In other cases, the pot lid 230 forms an airtight seal around the pot 220, for example when the cooking appliance is a pressure cooker. The state detection module 435 can receive a pressure measurement from the pot 210 and determine whether the lid is open or closed based on the measured pressure. For example, if the cooking appliance 110 attempts to pressurize the pot 210, the state detection module 435 determines that the lid is closed if the pressure increases and determines that the lid is open if the pressure does not increase. In still other embodiments, the lid 230 can electrically couple to the pot 220 when the lid is placed on the pot. The state detection module 435 receives a signal when the lid electrically couples to the pot, enabling the state detection module 435 to determine that the lid is present or absent based on whether the signal is detected.

In another example, the physical state detected by the state detection module 435 includes an amount of food that has been added to the pot 220. The amount of food can in some cases be represented by a weight, and the state detection module 435 can detect the amount of food based on signals received from the load cells 240. Alternatively, the state detection module 435 can determine the amount of food by measuring a fill level of the pot 220 using one or more sensors placed in the pot 220 or the lid 230. For example, the state detection module 435 can receive a signal from an optical sensor in the lid 230 that indicates a distance from the lid to a surface of food in the pot. Optical or resistance sensors can additionally or alternatively be placed at varying heights in the pot and detect whether the food has reached the corresponding height.

Another example of a physical state that can be detected by the state detection module 435 is the presence or absence of an accessory. Various accessories can be used with the cooking appliance 110, such as a thermometer, magnetic stirrer, vacuum seal lid, or ice pack. In some cases, the accessory can electronically couple to the cooking appliance 110, and the state detection module 435 can detect the accessory is present based on an electrical signal received from the accessory (e.g. via a direct electrical connection, or wirelessly via RFID, NFC, Bluetooth, induction, etc.). In other cases, the state detection module 435 can detect a weight increase measured by the load cells 240 correspond to an accessory that has been added to the appliance 110.

Still another physical state that can be detected by the state detection module 435 is a thermal resistance of the pot 220. The thermal resistance represents a resistivity of the pot 220 to conducting heat. For example, more heat may need to be applied to a pot with a high thermal resistance in order to cook food in the pot to a specified temperature, whereas less heat can be applied to a pot with a lower thermal resistance. To measure the thermal resistance of the pot 220, the state detection module 435 can measure a temperature gradient between two locations on the pot 220 after a specified amount of heat has been applied to the pot for a specified amount of time. Alternatively, the state detection module 435 can measure a temperature at a position separated from a location on the pot where the heat is applied, and determine a relative thermal resistivity of the pot 220 by comparing the temperature to temperatures measured at the same location on other pots. For example, embodiments of the cooking appliance 110 as shown for example in FIGS. 2A-2F can include a heating element 222 inside the pot 220 (i.e., applying heat to an interior surface of the pot) and temperature sensors 242 in the base 210 that are configured to measure a temperature at an exterior of the pot 220. The state detection module 435 can cause the heating element 222 to output a determined amount of heat for a specified amount of time, and can receive the temperature measurements at the exterior of the pot after the specified amount of time to determine the conductivity of heat through the wall of the pot. Alternatively, the state detection module 435 can receive temperature measurements at other locations on the pot, such as a known distance up a sidewall of the pot, to determine the thermal resistance of the pot. Alternatively, the state detection module 435 can receive first temperature measurements over time from a first thermometer in the pot and second temperature measurements over time from a second thermometer located on an external surface of the pot, wherein the state detection module is configured to compare the first and second temperature measurements over time to determine the thermal resistance of the pot.

The appliance control module 425 applies settings to the cooking appliance 110 to regulate cooking parameters. In various embodiments, the appliance control module 425 can apply settings to the appliance 110 that correspond to cooking parameters specified in a recipe. Alternatively, the module 425 can calculate parameters to achieve a desired ending characteristic of a cooked food product based on a size or dimensions of a food item or ingredient, outcomes previously achieved by the cooking appliance 110, and/or preferences of the user.

The appliance control module 425 can calculate parameters based on the amount of food or an amount of an ingredient a user uses while cooking a recipe. In some embodiments, the appliance control module 425 uses the amount of the food or ingredient and the desired ending characteristics as inputs to a model to determine a cooking time and a cooking temperature to cook the food to achieve the desired or preset ending characteristics. In other embodiments, the appliance control module 425 can use lookup tables, analytically or numerically solvable equations, or simulations to determine parameters to achieve the ending characteristics based on the amount of the food or ingredient.

The appliance control module 425 can additionally or alternatively calculate parameters to achieve a cooking outcome. The cooking outcome can include any detectable property of food, such as a post-cooking weight, temperature, or volume. In some cases, the appliance control module 425 processes user inputs to extract an intended outcome. User inputs can be matched to stored templates and, based on the matching, the appliance control module 425 can calculate parameters to achieve the requested outcome. Some templates can include a trigger word and a value, where the trigger word instructs the appliance 110 to perform a particular type of action, and the value quantifies the action. For example, the appliance control module 425 can process the trigger word “reduce” as a command to cook food until its weight has been reduced by a specified amount. If the appliance control module 425 receives the verbal instruction “Reduce my sauce by 25%,” the appliance control module 425 can extract the trigger word “reduce” and the value “25%” to determine that the user intended the appliance 110 to cook its contents until the weight of the contents has been reduced by 25%. For a command like “Protect my sauce, the appliance control module 425 can extract “protect”, recognize the prior command of “reduce” and therefore reduce heat to low once the weight of the contents has been reduced by a previously specified value.

In some embodiments, the appliance control module 425 adjusts settings of the cooking appliance automatically based on an evaluation of past cooking sessions. When a user cooks food using a recipe, the user can provide information about a resulting condition of the food, for example by inputting the result into the user device 120. Cooking results can include quantifiable results, such as the final temperature of food, or subjective results such a texture of the food or whether the food was burned. The appliance control module 425 receives the result and uses the result to train a model for calculating cooking parameters for the food. When the appliance 110 is used to cook food, the appliance control module 425 can use the model to select cooking parameters before applying the parameters to the appliance 110.

In some embodiments, the appliance control module 425 adjusts settings of the cooking appliance 110 based on user preferences. A user may, for example, prefer cooking a particular food item for a different period of time or at a different temperature than specified by a recipe. If the user provides feedback about his preferences, the appliance control module 425 can store the preferences and apply them each time the user uses the cooking appliance 110. For example, if the user inputs a setting to cook meat until it is “well-done,” the appliance control module 425 retrieves the setting each time the user prepares a meat item and calculates a cook time that will cause the meat to be cooked until it is well-done.

The communications module 430 enables communication between the cooking appliance 110 and external devices or users. Communications enabled by the communications module 430 can include wireless transmitting data to or receiving data from another cooking appliance 110, the user device 120, or the server 130, or can include receiving inputs from the user and outputting information to the user. By sending data to or receiving data from other appliances, the communications module 430 can synchronize the appliance 110 with other connected appliances. For example, the communications module 430 can output announcements about statuses of other devices and can cause the cooking times of multiple appliances to end at approximately the same time. In some embodiments, the communications module 430 can comprise a speech synthesizer that generates synthesized speech and outputs the speech to a user by a speaker of the cooking appliance 110. The communications module 430 can also control a display of the cooking appliance 110, for example, to change displayed content in response to conversational inputs from a user.

The display module 440 controls display devices of the cooking appliance 110 to output information to a user. The display module 440 can receive data from the state detection module 435 or the appliance control module 315 to output to a user, or the display module 440 can output information responsive to analysis of a voice command by the speech processing module 415. For example, the display module 440 can output information about settings applied to the cooking appliance, where the settings can be applied by the user or by the cooking appliance in response to detecting a change in the physical state of the appliance, while executing a recipe, or based on other factors.

The display module 440 controls display devices of the cooking appliance 110 to output information to a user. The display module 440 can receive data from the state detection module 435 or the appliance control module 315 to output to a user, or the display module 440 can output information responsive to analysis of a voice command by the speech processing module 415. For example, the display module 440 can output information about settings applied to the cooking appliance, where the settings can be applied by the user or by the cooking appliance in response to detecting a change in the physical state of the appliance, while executing a recipe, or based on other factors.

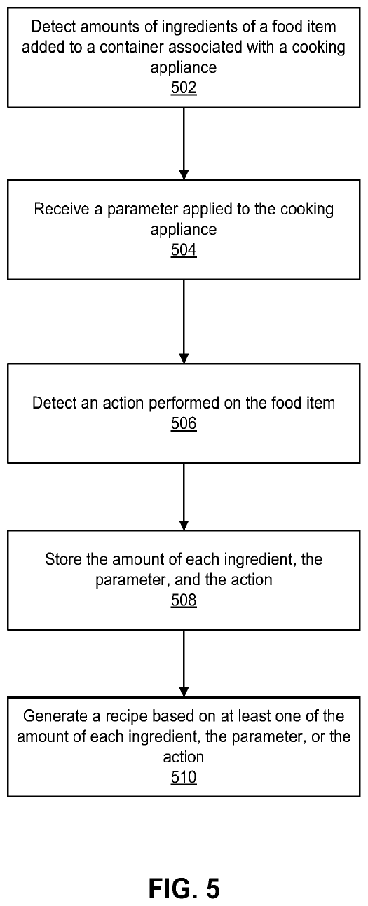

FIG. 5 is a flowchart illustrating a process 500 for generating a recipe using a cooking appliance, according to one embodiment. In some embodiments, the process 500 is performed by a cooking appliance 110 comprising a scale, a processor coupled to the scale, and a computer-readable storage medium storing computer program instructions executable by the processor. Other embodiments of the process 500 can include additional, fewer, or different steps, and the steps can be performed in different orders.

As shown in FIG. 5, the cooking appliance 110 detects at block 502 a weight of each of multiple ingredients of food that have been added to a container associated with the cooking appliance. The ingredient weights can be measured by the scale. In some embodiments, the cooking appliance 110 receives an identifier of each ingredient and stores the ingredient weights in association with respective identifiers. The identifier can be extracted from a speech input received by the appliance 110. As the user is adding an ingredient, for example, the user can speak a command such as “I am adding onion.” The cooking appliance 110 processes the user's speech to extract the ingredient name “onion,” and stores the weight of content added to the container as being a weight of onion used in the recipe. The identifier can alternatively be received from the user device 120. For example, the user can type the name of the ingredient into the user device 120 or select the ingredient name from a list displayed by the user device.

The cooking appliance 110 receives at block 504 a parameter for cooking the food. The cooking appliance 110 can determine the parameter from a setting input by the user. Settings can be input directly to the cooking appliance 110 (e.g., by interacting with a user interface of the appliance) or input to the user device 120 and transmitted to the appliance 110. In some cases, the cooking appliance 110 receives a voice command from the user and sets a parameter based on the voice command. The voice commands can provide specific instructions for setting the parameter. For example, an instruction to “Turn up the heat” can cause the cooking appliance 110 to increase the heat output from the heating element. Other voice commands can specify outcomes for the food, and the cooking appliance 110 determines parameters that will achieve each outcome. For example, the user may instruct the appliance to “Protect my sauce” or “Reduce the sauce by 25%.” In some embodiments, the user can delegate a “chef” who provides the settings (or other inputs related to the cooking process). The chef can be, for example, a person, a profile affiliated with one or more people, or an artificial intelligence personality that can select and apply settings to the cooking appliance 110. If a chef has been delegated, the cooking appliance 110 may apply settings received from the chef and not apply settings received from other sources that are not the designated chef.

The cooking appliance 110 can detect at block 506 an action the user performs on the food. In one embodiment, the cooking appliance 110 detects that the user has stirred the food based on changes in weights of the ingredients in the cooking container. As food is stirred, the weight of the food can be dynamically shifted around the container in a pattern that is detectable by multiple weight sensors. To detect stirring, the cooking appliance 110 can detect that the weight measured by the weight sensors is not statically distributed across the container but rather is dynamically changing for a period of time. The cooking appliance 110 can apply a heuristic or model to the weights measured by the weight sensors to output a determination that the food was stirred. The heuristic or model can take into account factors such as a pattern of the dynamic weight measurements and an amount of time the pattern was detected. For example, stirring can cause the contents of the container to shift cyclically around the container, increasing the weight measured by one weight sensor while decreasing the weights measured by the other sensors until the weight shifts to an adjacent sensor, and repeating for each sensor in order around the container for at least a threshold amount of time. Another action that can be detected by the cooking appliance 110 at block 506 is a rate at which one of the ingredients is added to the container. The rate can be measured by detecting a rate of change of the overall weight measured by the scale as the user adds the ingredient. In still another embodiment, the cooking appliance 110 can use cameras to capture one or more motions used while the user cooks the food.

At block 508, the cooking appliance 110 stores the amount of each ingredient added to the cooking container and the parameter. Based on at least one of the ingredient amounts, the parameter, or the action, the cooking appliance 110 generates at block 510 a recipe for cooking the food. The recipe specifies a process for cooking the food and can include both steps for a user to perform and actions that can be automatically executed by the cooking appliance 110. When generating the recipe, the cooking appliance 110 can generate an ordered list of user-performed steps and appliance-performed actions that follow the activities captured during the process 500. In some cases, the cooking appliance 110 can simplify the recipe by aggregating similar steps or actions and can display the generated recipe to the user to make any desired modifications. Further, the cooking appliance, user device, or other devices can receive captured photos or videos to link to the recipe to thereby provide a multimedia recipe that can be shared via a social network.

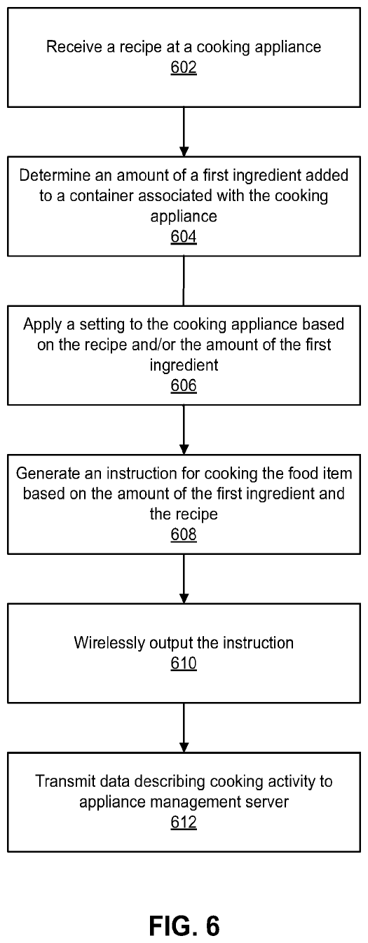

FIG. 6 is a flowchart illustrating a process 600 for applying a recipe at a cooking appliance, according to one embodiment. The process 600 can be performed by a cooking appliance 110, such as a pressure cooker, immersion circulator, or another type of appliance that can be used in a process to prepare food for consumption. For example, the process 600 can be performed by the base 210 of the pressure cooker 200, which is configured to measure weights of items added to a container placed on the base and can communicate with one or more external devices, such as the user device 120.

As shown in FIG. 6, the cooking appliance 110 receives at block 602 at least a portion of a recipe that defines a process for cooking food. The recipe can include an amount of at least a first ingredient in the recipe for the food. A recipe can also specify a rate at which the first ingredient should be added to the container. For example, the recipe can direct a user to add the first ingredient over a specified period of time (e.g., pouring two cups of an ingredient into the container over the course of thirty seconds), or can direct a user to add specified amounts of the first ingredient at specified intervals (e.g., add approximately one fourth of the ingredient to the container every ten minutes). A recipe can further include a parameter for cooking the food, such as a cook time or a cooking temperature.

The cooking appliance 110 determines at block 604 an amount of the first ingredient that was added to a container associated with the appliance. In some embodiments, the cooking appliance includes a scale and determines the amount of the first ingredient by measuring the weight of the added ingredient using the scale. In other cases, the cooking appliance receives a measurement of dimensions of the ingredient from the user device 120. The dimensions of the ingredient can be manually inputted by the user, or the user device 120 can calculate the dimensions from a picture of the ingredient.

The cooking appliance 110 applies at block 606 a setting based on the recipe and/or the amount of the first ingredient. In some embodiments, the cooking appliance applies a setting to the cooking appliance based on the parameter specified in the recipe and the amount of the first ingredient. If the parameter includes, for example, an internal temperature to which the food should be cooked, the cooking appliance 110 can determine a cook time that accounts for the quantity of the food and the fact that heating food to a specified temperature often takes longer for higher quantities of food than for lower quantities of food. Accordingly, the cooking appliance 110 can determine an amount of time the food should be cooked to reach the temperature specified in the recipe based on the amount of the first ingredient the user added to the cooking container. The cooking appliance 110 can configure a cook time setting to cook the food for the determined amount of time.

If, instead, the parameter in the recipe specifies a temperature output by a heating element of the cooking appliance 110, the cooking appliance 110 can apply a temperature setting to the appliance's heating element at block 606 to match the recipe parameter. The appliance 110 can, for example, apply a setting to the heating element to output the temperature specified in the recipe. In some cases, the cooking appliance 110 can adjust the temperature setting if the user pauses or stops the cooking process, or if the user does not perform actions in the cooking process at the same rate as they are performed in the recipe. For example, the user may not remove a cooked food item from the container immediately but rather may leave the food cooking until the user returns home, until other food items are finished cooking, or for other reasons. To avoid overcooking the food, the cooking appliance 110 can reduce the temperature setting if the user does not remove the food from the container within a threshold amount of time after the end of the set cook time. The cooking appliance 110 can calculate the threshold based on the amount of food in the container. For example, because smaller quantities of food can burn or overcook more easily than larger quantities of food, the threshold can be shorter for lower quantities of food than for higher quantities of food. The cooking appliance 110 can also lower the temperature set point of the heating element in response to a command received from the user. For example, if the user speaks a command such as “Hold the fort for thirty minutes,” the cooking appliance 110 reduces the temperature setting for thirty minutes before resetting the temperature to that specified in the recipe.

In some embodiments, the cooking appliance 110 at block 606 further applies a setting based on the user's previous use of the appliance 110. The cooking appliance 110 can determine the setting based on preferences of the user that were captured in previous cooking sessions, or based on outcomes measured by the appliance 110 during the previous cooking sessions. Cooking outcomes can include quantifiable results, such as the final temperature of food, or subjective results such a texture of the food or whether the food was burned. The cooking outcomes can be input by a user after the user cooks food using a recipe. Based on the outcomes, the cooking appliance 110 can determine whether to adjust settings of the appliance the next time the recipe is used. For example, if following a recipe caused food to burn, the cooking appliance 110 can select a lower temperature setting or cook time than specified by the recipe. If the internal temperature of the food was too low at the end of a cook time calculated by the appliance 110, the cooking appliance 110 can use the measured internal temperature to improve cook time calculations for future recipes.

At block 608, the cooking appliance 110 generates an instruction for cooking the food item based on the amount of the first ingredient added to the container and the recipe. In some cases, the recipe includes an amount of a second ingredient, and the instruction generated at block 608 instructs the user to add a specified amount of the second ingredient to the container. The specified amount of the second ingredient can be calculated based on the amount of the first ingredient added to the cooking container and the relative amount in the recipe. For example, if the user adds more of the first ingredient than called for by the recipe, the cooking appliance 110 scales up the amount of the second ingredient that should be added in order to keep the relative proportions of the first and second ingredients consistent with the proportions in the recipe.

In another example, the cooking appliance 110 receives eating patterns of a user and recommends increasing or decreasing the amount of the first ingredient based on the eating patterns. For example, the cooking appliance 110 can determine, based on the user's eating patterns, that the user is likely to cook two servings of food on a given day rather than one serving. If the user adds an amount of an ingredient sufficient for one serving of food, the cooking appliance 110 can generate a recommendation that the user increase the amount of the ingredient until it is sufficient for two servings of the food.

In still another example, the cooking appliance 110 generates instructions that cause other cooking appliances to perform an action related to cooking food. The action can include applying a uniform command across communicatively coupled cooking appliances. For example, if the user inputs a command to pause the cooking process for a period of time, the cooking appliance 110 can generate an instruction that causes the communicatively coupled appliances to similarly pause cooking. Other instructions can cause individual cooking appliances to perform an action different from the action performed by other devices. If a user is preparing a meal using two appliances 110, one or both appliances can generate instructions that synchronize their cooking processes. For example, if a first food item being cooked by the appliance 110A will be finished ten minutes before appliance 110B finishes cooking a second food item, the appliance 110B can send a command to the appliance 110A to slow or hold its cooking process for ten minutes so that the first and second food items finish cooking at approximately the same time. Alternatively, when the appliance 110A finishes cooking its food item, it can reduce its temperature output to keep the food warm without overcooking it until an instruction is received indicating that the cooking appliance 110B has finished cooking its food item.

The cooking appliance 110 can additionally generate an instruction based on external support, such as customer support, help from professional or celebrity chefs, or advice of other users. The external support can be explicitly requested by the user (e.g., by interacting with the appliance 110 or the user device 120), or the cooking appliance 110 can retrieve the external support automatically at predetermined times in a recipe or if the user deviates from a recipe.

At block 610, the cooking appliance 110 wirelessly outputs the instruction. In some embodiments, the cooking appliance 110 outputs the instruction in a format comprehensible by a user. For example, the cooking appliance 110 outputs a verbal instruction that can be displayed by a display of the appliance 110 or synthesized into speech played by a speaker of the appliance 110. Other instructions can be output in non-verbal formats to the user, such as illuminating LEDs, playing an alert sound (e.g., a beep or a bell sound), or displaying a picture or animation on the display of the appliance 110.

In other embodiments, the cooking appliance 110 outputs the instruction at block 610 by sending a signal to an external device. For example, the appliance 110 can send a signal to the user device 120, where the signal includes the instruction. Based on the signal, the user device 120 can provide the instruction to the user by, for example, displaying words, pictures, or animations on the display of the user device 120, playing synthesized speech with verbal instructions through a speaker of the device 120 (e.g., “Add 2 mg more salt to your dish”), or playing an alert sound. The cooking appliance 110 can also output the instruction to another cooking appliance. For example, if a user is preparing a meal using the cooking appliances 110A and 110B, an instruction generated by one appliance (such as a recommendation to increase or decrease an amount of an ingredient) can be output by a signal transmitted by the appliance 110A to the appliance 110B. The appliance 110B can perform an action based on the instruction (such as increase or decrease a temperature output by the appliance) or can output the instruction to a user by playing a sound or synthesized verbal instruction, displaying the instruction on a display of the appliance 110B, or otherwise outputting the instruction in a format comprehensible by a user.

While the user is cooking food, the cooking appliance 110 can transmit at block 612 data describing the user's cooking activities to the appliance management server 130. The cooking activity data can be stored at the server 130 for later use or evaluation, for example, to extract cooking patterns of the user or user preferences, or to recommend a recipe to the user based on past recipes the user has cooked. The appliance management server 130 can also facilitate interactions between users or between users and appliances through tools such as a social network or private chat functionality. For example, the appliance management server 130 maintains a chat log, and the data transmitted by the cooking appliance 110 at block 612 is posted to the chat log. In some cases, the appliance management server 130 maintains a social network that connects users based on recipes they cook or characteristics of their cooking. The data the appliance 110 sends to the server 130 can be used by the server 130 to match the user to other similar users and enable the user to, for example, share recipes with the other users or receive cooking tips from the users. The appliance management server 130 in some cases awards prizes to users based on the data transmitted to the server by the cooking appliances 110. The prizes, including badges, awards on the social network, redeemable points or offers, or other types of gift can be awarded based on the users' cooking activities. For example, a badge can be awarded for every ten meals a user cooks using the cooking appliance 110. A food brand can provide electronic coupons to any user who uses ingredients sold by the brand in at least five dishes over a two-week period. A virtual trophy can be given to the user in a social network who cooks the greatest quantity of food among his connections in a month, or to the user who cooks the greatest number of unique food items in a month.

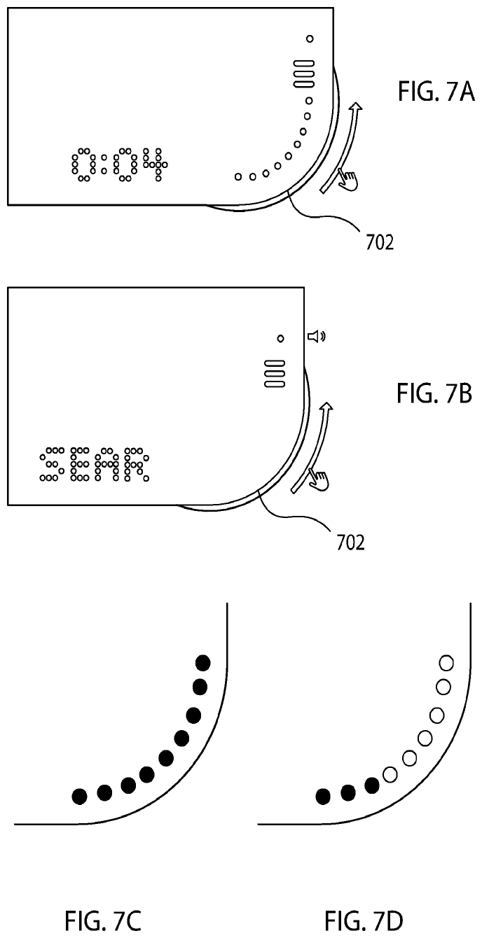

FIGS. 7A-7D illustrate example display devices that can be controlled by the display module 440. Exemplary information that can be displayed by the LED array 252, under the control of the display module 440, is shown in FIGS. 7A-7B. The display module 440 can control the LED array 252 to display words or numbers relating to, e.g. a state of the cooking appliance. For example, FIG. 7A shows that the LED array 252 can display a time (such as an amount of time remaining in a cooking program). FIG. 7B shows that the LED array 252 can display a cooking methodology that corresponds to temperature, time, or other settings of the cooking appliance 110. For example, the array 252 is shown in FIG. 7B as displaying the methodology “SEAR,” which can correspond to a particular set of appliance settings (e.g., a high heat setting for a short period of time). Other example cooking methodologies can include boiling, simmering, or keeping food warm. In some embodiments, the display module 440 receives a user input at a scroll wheel 702 and changes the information displayed by the LED array 252 in response to the user input. A user can turn the scroll wheel 702 discrete amounts that are facilitated by notches in the wheel, where each discrete rotation causes the display module 440 to cause different information in the LED array 252. For example, if the user rotates the scroll wheel 702 by one notch while the LED array 252 is displaying an amount of cook time remaining, the display module 440 can cause the LED array 252 to display the current cooking methodology applied to the appliance 110. As an alternative to notches, the scroll wheel can include a small magnet at its circumference, while the base can include a corresponding series of spaced apart magnets arranged along a curved path, so that the wheel selectively and magnetically engages with one of the series of magnets to thereby provide discrete manually rotatable positions for the wheel.

FIGS. 7C-7D illustrate that the display module 440 can cause the LED gauge 256 to display a parameter value of a parameter that has been applied to the cooking appliance 110. The parameter value represented by the LED gauge 256 can be any parameter of the cooking appliance 110 that falls within a range of possible values, such as cooking temperature, pressure within the pot 220, or fill level of the pot 220. To display the parameter value, the display module 440 can selectively turn on one or more of the LEDs in the LED gauge 256 based on a ratio between the parameter value and a size of the range of possible values for the parameter (e.g., a difference between a maximum possible value and a minimum possible value). If the parameter value is approximately equivalent to the highest possible value for the parameter, the display module 440 can turn on every LED in the gauge 256. If the parameter value is approximately equivalent to the lowest possible value for the parameter, the display module 440 can turn on zero or one LEDs in the gauge 256 and not turn on the other LEDs. The display module 440 can selectively and sequentially turn on the LEDs for parameter values between the minimum and maximum.

For example, if the cooking temperature of the appliance 110 can fall within a range of values between 100° F. and 300° F., the display module 440 can turn on one LED when the temperature is set to near 100° F. and can sequentially turn on another LED for each 25° increase in the temperature until every LED is illuminated for a temperature setting near 300° F. FIG. 7C illustrates an example of the LED gauge 256 when the temperature of the appliance 110 is set to approximately 300° F. and the display module 440 illuminates every LED in the gauge 256. FIG. 7D illustrates an example when the temperature of the appliance 110 is set to approximately 150° F. and the display module 440 illuminates three of the nine LEDs in the gauge 256. In these examples, the relationship between the number of LEDs illuminated and the ratio of the parameter value and the size of the range of possible values is approximately linear. However, the relationship can instead be approximately exponential or approximately logarithmic. Also, if a maximum temperature is exceeded, e.g. at a temperature above 300° F., then all LEDs can be illuminated and flash to warn a user, before decreasing the temperature.

The display module 440 can cause the LED gauge 256 to display parameter values for multiple different parameters of the cooking appliance 110. While a first parameter value is displayed by the gauge 256, the display module 440 can receive a user input to display a value of a second parameter. For example, if the current cooking temperature is displayed by the gauge 256, a user can provide an input to display the current pressure in the pot 220. In response to the user input, the display module 440 calculates a number of LEDs to turn on based on a ratio between the second parameter value and a size of a range of possible values for the second parameter, and turns on or turns off one or more LEDs until the calculated number of LEDs are illuminated. In some cases, the display module 440 can represent different parameters by illuminating LEDs of different colors. For example, a value of a first parameter can be displayed by illuminating one or more LEDs of a first color, and a value of a second parameter can be displayed by illuminating one or more LEDs of a second color. Additionally or alternatively, the display module 440 can cause another display device of the cooking appliance 110 to identify the parameter that is currently displayed by the LED gauge 256. In some cases, the display module 440 can cause the LED gauge 256 to display a parameter value if the parameter value is changing. For example, if the user is pouring water into the pot 220, the display module 440 can cause the LED gauge 256 to display the increasing fill level of the pot 220. If the user then adjusts the cooking temperature of the appliance 110, the display module 440 can switch the LED gauge 256 to indicate the current temperature setting as the user adjusts it.

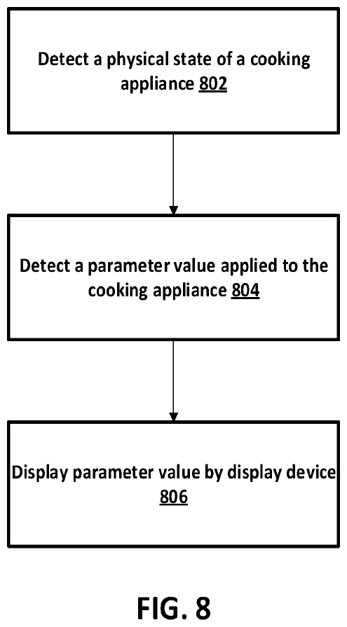

FIG. 8 is a flowchart illustrating a process for a cooking appliance to manage user interactions with the appliance. The process shown in FIG. 8 can be performed by the cooking appliance 110, such as by one or more processors associated with the cooking appliance 110. The process can include additional or different steps, and the steps can be performed in different orders.

The cooking appliance 110 can detect, at block 802, a physical state of the cooking appliance 110. The physical state can include the presence or absence of physical items associated with the appliance 110 or properties of components of the appliance 110. As described with respect to FIG. 3, the cooking appliance 110 can detect the physical state based on a variety of factors, such as a weight measured by the load cells 240, electrical signals transmitted between components of the appliance, pressure inside the pot 220, fill level detected by fill level sensors associated with the pot 220, or temperature measured by the temperature sensors 242.

The cooking appliance 110 can detect, at block 804, a parameter value applied to the cooking appliance 110 for one or more parameters. In some cases, the appliance 110 can set the parameter value based on the physical state detected at block 802. In other cases, the parameter value can be set by a user of the appliance 110 or by the appliance 110 when executing a cooking program. The parameter value can fall within a range of possible values for the parameter. For example, the cooking appliance 110 can be configured to output a specified range of temperatures, and the parameter value can be a temperature between a minimum and a maximum temperature in the specified temperature range.

The cooking appliance 110 can cause, at block 806, one or more display devices to display the parameter value. The display devices can include an LED gauge that comprises multiple LEDs. To display the parameter value by the LED gauge, the cooking appliance 110 can selectively turn on one or more of the multiple LEDs based on a proportion between the parameter value and a size of the range of possible values for the parameter. For example, the cooking appliance 110 can calculate a number of LEDs to turn on by calculating a ratio between the parameter value and a difference between a maximum value and a minimum value in the range.

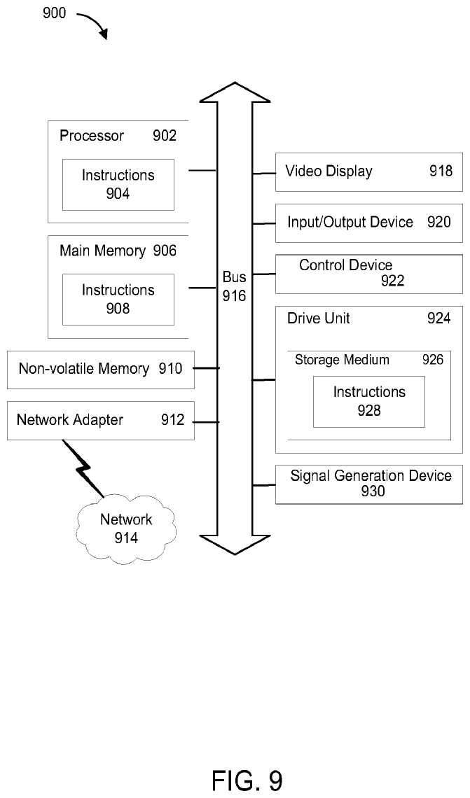

FIG. 9 is a block diagram illustrating an exemplary processing system 900 in which at least some operations described herein can be implemented. For example, the user device 120 or appliance management server 130 can be implemented as the example processing system 900. The processing system 900 can include one or more central processing units (“processors”) 902, main memory 906, non-volatile memory 910, network adapter 912 (e.g., network interfaces), video display 918, input/output devices 920, control device 922 (e.g., keyboard and pointing devices), drive unit 924 including a storage medium 926, and signal generation device 930 that are communicatively connected to a bus 916. The bus 916 is illustrated as an abstraction that represents any one or more separate physical buses, point to point connections, or both connected by appropriate bridges, adapters, or controllers. The bus 916, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 994 bus, also called “Firewire.”

In various embodiments, the processing system 900 operates as part of a user device, although the processing system 900 can also be connected (e.g., wired or wirelessly) to the user device. In a networked deployment, the processing system 900 can operate in the capacity of a server or a client machine in a client-server network environment, or as a peer machine in a peer-to-peer (or distributed) network environment.

The processing system 900 can be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, elevision-connected devices, or any portable device or machine capable of executing a set of instructions (sequential or otherwise) that specify actions to be taken by the processing system 900.

While the main memory 906, non-volatile memory 910, and storage medium 926 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 928. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, can be implemented as part of an operating system or a specific application, component, program, object, module or sequence of instructions referred to as “computer programs.” The computer programs typically comprise one or more instructions (e.g., instructions 904, 908, 928) set at various times in various memory and storage devices in a computer, and that, when read and executed by one or more processing units or processors 902, cause the processing system 900 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 910, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 912 enables the processing system 900 to mediate data in a network 914 with an entity that is external to the processing system 900 through any known and/or convenient communications protocol supported by the processing system 900 and the external entity. The network adapter 912 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 912 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including, for example, the access and operation rights of an object by an individual, a machine, and/or an application, and the circumstances under which the permission rights stand.

Clauses further defining aspects and embodiments of the described technology are provided below:

Clause 1. A cooking appliance, comprising: a scale; a processor coupled to the scale; and a non-transitory computer readable storage medium storing executable computer program instructions, the computer program instructions when executed by the processor causing the processor to: detect, using the scale, weights of each of multiple ingredients of food added to a container associated with the cooking appliance; receive a parameter of the cooking appliance for cooking the food; and generate based on the weights and the received parameter, a recipe defining a process for cooking the food.
Clause 2. The cooking appliance of Clause 1, wherein the computer program instructions when executed further cause the processor to: receive a speech input; extract, from the speech input, an identification of an ingredient of the multiple ingredients; and store the weight of the ingredient in association with the identification.
Clause 3. The cooking appliance of Clause 1 or 2, wherein receiving the parameter comprises receiving a voice command to change a setting of the cooking appliance, and wherein the computer program instructions when executed further cause the processor to change the setting of the cooking appliance in response to the voice command.
Clause 4. The cooking appliance of Clause 3, wherein the computer program instructions when executed further cause the processor to: extract from the voice command, a trigger word and a value; wherein changing the setting of the cooking appliance in response to the voice command comprises performing an action corresponding to the trigger word and quantified by the value.
Clause 5. The cooking appliance of any one of Clause 1 to 4, wherein the computer program instructions when executed further cause the processor to: detect a rate at which an ingredient of the multiple ingredients is added to the container; wherein the recipe further specifies the rate.
Clause 6. The cooking appliance of any one of Clause 1 to 5, wherein the computer program instructions when executed further cause the processor to: capture a motion performed by a user while the user uses the cooking appliance to prepare the food; wherein the recipe further specifies the motion.
Clause 7. The cooking appliance of any one of Clauses 1 to 6, wherein the computer program instructions when executed further cause the processor to: identify an order in which the multiple ingredients are added to the container; wherein the recipe further specifies the order.
Clause 8. The cooking appliance any one of Clauses 1 to 7, wherein the computer program instructions when executed further cause the processor to: detect by the scale, a user has stirred the food in the container; wherein the recipe further identifies a time the user stirred the food relative to one or more other steps of the process for cooking the food.
Clause 9. The cooking appliance of any one of Clauses 1 to 8, wherein the computer program instructions when executed further cause the processor to: display a first datum on a display associated with the cooking appliance; detect a voice input from a user; and responsive to detecting the voice input, display a second datum on the display.
Clause 10. The cooking appliance of any one of Clauses 1 to 9, further comprising a camera coupled to the processor and positioned to capture image data of the container, wherein the computer program instructions when executed by the processor further cause the processor to detect a fill level in the container based on the image data received from the camera.
Clause 11. The cooking appliance of any one of Clauses 1 to 10, further comprising a base configured to support the cooking container and to electrically couple to the cooking container to cause food in the cooking container to be cooked, wherein the scale is housed in the base; wherein the processor is further configured to: detect one or more physical items that have been added to or removed from the base using a weight measured by the scale; and responsive to detecting the one or more physical items have been added or removed, apply a setting to the cooking appliance, based on the detection of the one or more physical items, to cook the food in the cooking container.
Clause 12. The cooking appliance of Clause 11, further comprising a light emitting diode (LED) gauge in the base, the LED gauge including multiple LEDs, and wherein the processor is configured to: selectively turn on one or more of the multiple LEDs based on a value of the setting applied to the cooking appliance relative to a range of possible values for the setting.
Clause 13. The cooking appliance of Clause 11 or 12, wherein the one or more physical items comprises the cooking container, and wherein detecting the cooking container has been added to or removed from the base comprises detecting a change in the weight measured by the scale that corresponds to an expected weight for the cooking container.
Clause 14. The cooking appliance of any one of Clauses 11 to 12, wherein the one or more physical items comprises the cooking container, and wherein the computer program code further causes the processor to detect the cooking container has been added to or removed from the base using an electrical signal transmitted between the cooking container and the base.
Clause 15. The cooking appliance of any one of Clause 11 to 12, wherein the one or more physical items comprises the cooking container, and wherein the computer program code further causes the processor to identify the cooking container based on at least one of detecting a weight of the cooking container or receiving an electrical signal from the cooking container.
Clause 16. The cooking appliance of any one of Clauses 11 to 15, wherein the one or more physical items comprises a lid for the cooking container, and wherein detecting the lid has been added to or removed from the base comprises detecting a change in the weight measured by the scale that corresponds to an expected weight for the lid.
Clause 17. The cooking appliance of any one of Clause 11 to 15, wherein the one or more physical items comprises a lid for the cooking container, and wherein the computer program code further causes the processor to detect the lid has been added to or removed from the base using an electrical signal transmitted between the lid and the cooking container.
Clause 18. The cooking appliance of any one of Clauses 11 to 17, wherein the one or more physical items comprises a liquid or one or more food ingredients added to the cooking container, and wherein the computer program code further causes the processor to detect a fill level of the container after the liquid or one or more food ingredients have been added.
Clause 19. A cooking appliance comprising: a processor coupled to the scale; and a non-transitory computer readable storage medium storing executable computer program instructions, the computer program instructions when executed by the processor causing the processor to: receive at least a portion of a recipe, wherein the recipe defines a process for cooking food and an amount of at least a first ingredient in the recipe for the food; determine an amount of the first ingredient added during execution of the recipe; generate an instruction for cooking the food based on the amount of the first ingredient added; and wirelessly output the instruction by the cooking appliance.
Clause 20. The cooking appliance of Clause 19, wherein the cooking appliance comprises a scale coupled to the processor, wherein the processor is configured to determine the amount of the first ingredient by receiving a signal from the scale indicative of the weight measured of the first ingredient.
Clause 21. The cooking appliance of Clause 19 to 20, wherein the processor is configured to determine the amount of the first ingredient by: receiving at least one dimension of the first ingredient, the at least one dimension calculated based on a photograph of the first ingredient.
Clause 22. The cooking appliance of any one of Clauses 19 to 21, wherein the recipe specifies an amount of a second ingredient, and wherein the processor is configured to generate the instruction to indicate to a user of the cooking appliance to use an amount of the second ingredient that is determined based on the amount of the second ingredient specified in the recipe and the amount of the first ingredient added.
Clause 23. The cooking appliance of any one of Clauses 19 to 22, wherein the cooking appliance includes a container, and wherein the processor is configured to generate the instruction to: determine an eating pattern of a user of the cooking appliance; and recommend increasing or decreasing the amount of the first ingredient added to the container based on the eating pattern.
Clause 24. The cooking appliance of any one of Clauses 19 to 22, wherein the cooking appliance includes a container, and wherein the processor is configured to generate the instruction to: receive an input specifying a number of servings of the food to be made; and recommend increasing or decreasing the amount of the first ingredient added to the container based on the number of servings.
Clause 25. The cooking appliance of any one of Clauses 19 to 24, wherein the processor is configured to generate the instruction to: determine a rate at which a user is adding the first ingredient; and instruct the user to decrease the rate.
Clause 26. The cooking appliance of any one of Clauses 19 to 25, wherein generating the instruction is configured to instruct a user to stir the food.
Clause 27. The cooking appliance of any one of Clauses 19 to 26, wherein the cooking appliance is communicatively coupled to another cooking appliance, and wherein the processor is configured to generate the instruction to generate a command to cause the other cooking appliance to perform an action.
Clause 28. The cooking appliance of any one of Clauses 19 to 27, wherein the processor is configured to announce, a status of the other cooking appliance.
Clause 29. The cooking appliance of any one of Clauses 19 to 28, wherein the recipe further specifies a parameter for cooking the food, and wherein the processor is configured to: apply a setting to the cooking appliance based on the parameter and the amount of the first ingredient added; access a stored user preference; and apply the setting further based on the user preference.
Clause 30. The cooking appliance of any one of Clauses 19 to 29, wherein the processor is configured to: output information about the cooking appliance or the process for cooking the food to a server; receive from the server, customer support or chef support generated based on the information about the cooking appliance or the process for cooking the food; and generate the instruction further based on the customer support or chef support.
Clause 31. The cooking appliance of Clause 30, wherein the cooking appliance is further configured to receive from the server, a recommended recipe selected by the server based on the output information.
Clause 32. The cooking appliance of any one of Clauses 19 to 31, further comprising a base configured to support the cooking container and to electrically couple to the cooking container to cause food in the cooking container to be cooked, a scale housed in the base; wherein the processor is further configured to: detect a physical item has been added to or removed from the base using a weight measured by the scale; and responsive to detecting the physical item has been added or removed, apply a setting to the cooking appliance, based on the detection of the physical item, to cook the food in the cooking container.
Clause 33. The cooking appliance of Clause 32, further comprising a light emitting diode (LED) gauge in the base, the LED gauge including multiple LEDs, and wherein the processor is configured to: selectively turn on one or more of the multiple LEDs based on a value of the setting applied to the cooking appliance relative to a range of possible values for the setting.
Clause 34. The cooking appliance of Clause 32 or 33, wherein the physical item comprises the cooking container, and wherein detecting the cooking container has been added to or removed from the base comprises detecting a change in the weight measured by the scale that corresponds to an expected weight for the cooking container.
Clause 35. The cooking appliance of any one of Clauses 32 to 33, wherein the physical item comprises the cooking container, and wherein the computer program code further causes the processor to detect the cooking container has been added to or removed from the base using an electrical signal transmitted between the cooking container and the base.
Clause 36. The cooking appliance of any one of Clauses 32 to 33, wherein the physical item comprises the cooking container, and wherein the computer program code further causes the processor to identify the cooking container based on at least one of detecting a weight of the cooking container or receiving an electrical signal from the cooking container.
Clause 37. The cooking appliance of any one of Clauses 32 to 36, wherein the physical item comprises a lid for the cooking container, and wherein detecting the lid has been added to or removed from the base comprises detecting a change in the weight measured by the scale that corresponds to an expected weight for the lid.
Clause 38. The cooking appliance of any one of Clauses 32 to 36, wherein the physical item comprises a lid for the cooking container, and wherein the computer program code further causes the processor to detect the lid has been added to or removed from the base using an electrical signal transmitted between the lid and the cooking container.
Clause 39. The cooking appliance of any one of Clauses 32 to 38, wherein the physical item comprises a liquid or one or more food ingredients added to the cooking container, and wherein the computer program code further causes the processor to detect a fill level of the container after the liquid or one or more food ingredients has been added.
Clause 40. A system comprising: a cooking appliance configured according to any one of Clauses 1 to 18; and another cooking appliance configured according to any one of Clauses 19 to 39; wherein the processor of the cooking appliance is configured to transfer the instruction to generate a command to cause the another cooking appliance to perform an action.
Clause 41. A method, comprising: detecting, at a cooking appliance which comprises a scale, weights of each of multiple ingredients of food added to a container associated with the cooking appliance; receiving, at the cooking appliance, a parameter of the cooking appliance for cooking the food; and generating, by the cooking appliance and based on the weights and the received parameter, a recipe defining a process for cooking the food.
Clause 42. The method of Clause 41, wherein the method further comprises: receiving, by the cooking appliance, a speech input; extracting, by the cooking appliance from the speech input, an identification of an ingredient of the multiple ingredients; and storing, by the cooking appliance, the weight of the ingredient in association with the identification.
Clause 43. The method of Clause 41 or 42, wherein receiving the parameter comprises receiving a voice command to change a setting of the cooking appliance in response to the voice command.
Clause 44. The method of Clause 43, further comprising: extracting, by the cooking appliance from the voice command, a trigger word and a value; wherein changing the setting of the cooking appliance in response to the voice command comprises performing, by the cooking appliance, an action corresponding to the trigger word and quantified by the value.
Clause 45. The method of any one of Clauses 41 to 44, wherein the method further comprises: detecting a rate at which an ingredient of the multiple ingredients is added to the container; wherein the recipe further specifies the rate.
Clause 46. The method of any one of Clauses 41 to 45, wherein the method further comprises: capturing, by the cooking appliance, a motion performed by a user while the user uses the cooking appliance to prepare the food; wherein the recipe further specifies the motion.
Clause 47. The method of any one of Clauses 41 to 46, wherein the method further comprises: Identifying, by the cooking appliance, an order in which the multiple ingredients are added to the container; wherein the recipe further specifies the order.
Clause 48. The method of any one of Clauses 41 to 47, wherein the method further comprises: detecting by a scale of the cooking appliance, a user has stirred the food in the container; wherein the recipe further identifies a time the user stirred the food relative to one or more other steps of the process for cooking the food.
Clause 49. The method of any one of Clauses 41 to 48, wherein the computer program instructions when executed further cause the processor to: display a first datum on a display associated with the cooking appliance; detect a voice input from a user; and responsive to detecting the voice input, display a second datum on the display.
Clause 50. The method of any one of Clauses 41 to 49, further comprising: capturing image data of a container of the cooking appliance using a camera of the cooking appliance; and detecting, by the cooking appliance, a fill level in the container based on the image data received from the camera.
Clause 51. The method of any one of Clauses 41 to 50, further comprising: detecting one or more physical items have been added to or removed from a base of the cooking appliance using a weight measured by the scale, wherein the base is configured to support the cooking container and to electrically couple to the cooking container to cause food in the cooking container to be cooked, wherein the scale is house in the base; and responsive to detecting the one or more physical items having been added or removed, applying a setting to the cooking appliance, based on the detection of the one or more physical items, to cook the food in the cooking container.
Clause 52. The method of Clause 51, wherein the cooking appliance further comprises a light emitting diode (LED) gauge in the base, the LED gauge including multiple LEDs, and wherein the method further comprises: selectively turning on one or more of the multiple LEDs based on a value of the setting applied to the cooking appliance relative to a range of possible values for the setting.
Clause 53. The method of Clause 51 or 52, wherein the one or more physical items comprise of the cooking container, and wherein detecting the cooking container has been added to or removed from the base comprises detecting a change in the weight measured by the scale that corresponds to an expected weight for the cooking container.
Clause 54. The method of any one of Clauses 51 to 52, wherein the method comprises detecting that the cooking container has been added to or removed from the base using an electrical signal transmitted between the cooking container and the base.
Clause 55. The method of any one of Clauses 51 to 54, wherein the method further comprises identifying the cooking container based on at least one of detecting a weight of the cooking container or receiving an electrical signal from the cooking container.
Clause 56. The method of any one of Clauses 51 to 55, wherein the one or more physical items comprises a lid for the cooking container, and wherein detecting the lid has been added to or removed from the base comprises detecting a change in the weight measured by the scale that corresponds to an expected weight for the lid.
Clause 57. The method of any one of Clauses 51 to 55, wherein the one or more physical items comprises a lid for the cooking container, and wherein the method further comprises causing the processor to detect the lid has been added to or removed from the base using an electrical signal transmitted between the lid and the cooking container.
Clause 58. The method of any one of Clauses 51 to 57, wherein the physical item comprises a liquid or one or more food ingredients added to the cooking container, and wherein the computer program code further causes the processor to detect a fill level of the container after the liquid or one or more food ingredients has been added.
Clause 59. A method comprising: receiving at a cooking appliance, at least a portion of a recipe, wherein the recipe defines a process for cooking food and an amount of at least a first ingredient in the recipe for the food; determining by the cooking appliance, an amount of the first ingredient added during execution of the recipe; generating an instruction for cooking the food based on the amount of the first ingredient added; and wirelessly outputting the instruction by the cooking appliance.
Clause 60. The method of Clause 59, wherein the cooking appliance comprises a scale, and wherein determining the amount of the first ingredient comprises: measuring a weight of the first ingredient by the scale.
Clause 61. The method of Clause 59 or 60, wherein determining the amount of the first ingredient comprises: receiving at least one dimension of the first ingredient, the dimension calculated based on a photograph of the first ingredient.
Clause 62. The method of any one of Clauses 59 to 61, wherein the recipe specifies an amount of a second ingredient, and wherein generating the instruction comprises: instructing a user of the cooking appliance to use an amount of the second ingredient that is determined based on the amount of the second ingredient specified in the recipe and the amount of the first ingredient added.
Clause 63. The method of any one of Clauses 59 to 62, wherein the cooking appliance includes a container, and wherein generating the instruction comprises: determining an eating pattern of a user of the cooking appliance; and recommending increasing or decreasing the amount of the first ingredient added to the container based on the eating pattern.
Clause 64. The method of any one of Clauses 59 to 62, wherein the cooking appliance includes a container, and wherein generating the instruction comprises: receiving an input specifying a number of servings of the food to be made; and recommending increasing or decreasing the amount of the first ingredient added to the container based on the number of servings.
Clause 65. The method of any one of Clauses 59 to 64, wherein generating the instruction comprises: determining a rate at which a user is adding the first ingredient; and instructing the user to decrease the rate.
Clause 66. The method of any one of Clauses 59 to 64, wherein generating the instruction comprises instructing a user to stir the food.
Clause 67. The method of any one of Clauses 59 to 66, wherein the cooking appliance is communicatively coupled to another cooking appliance, and wherein generating the instruction comprises generating a command to cause the other cooking appliance to perform an action.
Clause 68. The method of Clause 67, further comprising announcing by the cooking appliance, a status of the other cooking appliance.
Clause 69. The method of any one of Clause 59 to 68, wherein the recipe further specifies a parameter for cooking the food, and wherein the method further comprises: applying a setting to the cooking appliance based on the parameter and the amount of the first ingredient added; accessing a stored user preference; and applying the setting further based on the user preference.
Clause 70. The method of any one of Clause 59 to 69, further comprising: outputting information about the cooking appliance or the process for cooking the food to a server; receiving from the server, customer support or chef support generated based on the information about the cooking appliance or the process for cooking the food; and generating the instruction further based on the customer support or chef support.
Clause 71. The method of Clause 70, wherein the server is configured to award a prize based on the output information.
Clause 72. The method of Clause 70 or 71, wherein the server maintains a chat log, and wherein outputting the information to the server comprises posting the information to the chat log.
Clause 73. The method of any one of Clauses 70 to 72, further comprising receiving from the server, a recommended recipe selected by the server based on the output information.
Clause 74. The method of any one of Clauses 70 to 73, wherein the server outputs a conversation thread for display to a user of the cooking appliance, the conversation thread including at least one of the customer support, the chef support, or the instruction for cooking the food.
Clause 75. A cooking appliance, comprising: a base configured to support a cooking container and to electrically couple to the cooking container to cause food in the cooking container to be cooked; a scale housed in the base; and a processor coupled to the scale, the processor executing computer program code that causes the processor to: detect one or more physical items have been added to or removed from the base using a weight measured by the scale; and responsive to detecting the one or more physical items have been added or removed, apply a setting to the cooking appliance, based on the detection of the one or more physical items, to cook the food in the cooking container.
Clause 76. The cooking appliance of Clause 75, further comprising a light emitting diode (LED) gauge in the base, the LED gauge including multiple LEDs, and wherein the computer program code when executed further causes the processor to: selectively turn on one or more of the multiple LEDs based on a value of the setting applied to the cooking appliance relative to a range of possible values for the setting.
Clause 77. The cooking appliance of Clause 75 or 76, wherein the one or more physical items comprises the cooking container, and wherein detecting the cooking container has been added to or removed from the base comprises detecting a change in the weight measured by the scale that corresponds to an expected weight for the cooking container.
Clause 78. The cooking appliance of Clause 75 or 76, wherein the one or more physical items comprises the cooking container, and wherein the computer program code further causes the processor to detect the cooking container has been added to or removed from the base using an electrical signal transmitted between the cooking container and the base.
Clause 79. The cooking appliance of Clause 75 or 76, wherein the physical item comprises the cooking container, and wherein the computer program code further causes the processor to identify the cooking container based on at least one of detecting a weight of the cooking container or receiving an electrical signal from the cooking container.
Clause 80. The cooking appliance of any one of Clauses 75 to 79, wherein the one or more physical items comprises a lid for the cooking container, and wherein detecting the lid has been added to or removed from the base comprises detecting a change in the weight measured by the scale that corresponds to an expected weight for the lid.
Clause 81. The cooking appliance of any one of Clauses 75 to 79, wherein the one or more physical items comprises a lid for the cooking container, and wherein the computer program code further causes the processor to detect the lid has been added to or removed from the base using an electrical signal transmitted between the lid and the cooking container.
Clause 82. The cooking appliance of Clause 75 to 81, wherein the one or more physical items comprises a liquid or one or more food ingredients added to the cooking container, and wherein the computer program code further causes the processor to detect a fill level of the container after the liquid or one or more food ingredients has been added.
Clause 83. A cooking appliance, comprising: a light emitting element gauge including multiple light emitting elements; and a processor coupled to the gauge and executing computer program code that causes the processor to: detect a parameter value applied to the cooking appliance, the parameter value selected from a specified range of possible values for a parameter of the cooking appliance; and selectively turn on one or more of the multiple light emitting elements in the gauge based on the parameter value in proportion to the range of possible values.
Clause 84. The cooking appliance of Clause 83, wherein the multiple light emitting elements comprise light emitting diodes (LEDs), and wherein selectively turning on one or more of the multiple LEDs comprises: calculating a number of the multiple LEDs to turn on based on a ratio between the parameter value and a difference between a maximum and minimum value in the range of possible values.
Clause 85. The cooking appliance of Clause 83 or 84, wherein the parameter value is a value for a first parameter applied to the cooking appliance, and wherein the computer program code further causes the processor to: detect a second parameter value for a second parameter applied to the cooking appliance, the second parameter value selected from a second range of possible values for the second parameter; and selectively turn one or more of the multiple light emitting elements in the gauge based on the second parameter value in proportion to the second range of possible values.
Clause 86. The cooking appliance of any one of Clauses 83 to 85, wherein the multiple light emitting elements comprise light emitting diodes (LEDs), and wherein the multiple LEDs include multiple first color LEDs and multiple second color LEDs, and wherein the processor selectively turns on one or more of the first color LEDs based on the first parameter value and selectively turns on one or more of the second color LEDs based on the second parameter value.
Clause 87. The cooking appliance of any one of Clauses 83 to 86, wherein the multiple light emitting elements comprise light emitting diodes (LEDs), and wherein computer program code further causes the processor to, while the one or more LEDs are turned on based on the first parameter value: receive a command based on a user voice input to display the second parameter value; and in response to the command, selectively turning on the one or more LEDs based on the second parameter value.
Clause 88. The cooking appliance of any one of Clauses 83 to 87, wherein the cooking appliance further comprises a base that is configured to support a cooking container and electronically couple to the cooking container to cause food in the cooking container to be cooked, and wherein the gauge is housed in the base, and wherein the computer program code further causes the processor to: detect a physical item has been added to or removed from the base; determine the parameter value based on the detection; and apply the determined parameter value to the cooking appliance.
Clause 89. The cooking appliance of any one of Clauses 83 to 88, wherein detecting the parameter value comprises detecting a dynamic parameter value, and wherein the processor selectively turns on or turns off one or more of the light emitting elements as the dynamic parameter value changes.
Clause 90. A method comprising: detecting a physical state associated with the cooking appliance responsive to an electrical signal detected by a processor, wherein the cooking appliance comprises a base configured to support a cooking container and electrically couple to the cooking container to cause food in the cooking container to be cooked, and the processor housed in the base; and responsive to detecting the physical state, applying a setting to the cooking appliance, based on the detected physical state, to cook the food in the cooking container.
Clause 91. The method of Clause 90, wherein the cooking appliance further comprises one or more temperature sensors in the base and a heating element in the cooking container, wherein the electrical signal comprises a temperature signal generated by the one or more temperatures sensors and indicative of a temperature measurement at an exterior of the cooking container, and wherein the method comprises: causing a determined amount of heat to be output by the heating element; after a specified amount of time, detecting the temperature of the exterior of the cooking container using the temperature signal received from the one or more temperature sensors; determining a thermal resistance of the cooking container based on the temperature detected at the exterior of the cooking container; and applying the setting to the cooking appliance based on the determined thermal resistance.
Clause 92. The method of Clause 90 or 91, wherein the cooking appliance further comprises a light emitting diode (LED) gauge in the base, the LED gauge including multiple LEDs, wherein the method further comprises: selectively turning on one or more of the multiple LEDs based on a value of the setting applied to the cooking appliance relative to a range of possible values for the setting.
Clause 93. The method of any one of Clauses 90 to 92, wherein the physical state comprises the cooking container being coupled to the base, and wherein the method comprises detecting the cooking container is coupled to the base using an electrical signal transmitted between the cooking container and the base.
Clause 94. The method of any one of Clauses 90 to 93, wherein the physical state comprises a lid for the cooking container being closed, and wherein the method comprises detecting the lid has been closed using an electrical signal transmitted between the lid and the cooking container.
Clause 95. The method of any one of Clauses 90 to 94, wherein the cooking appliance further comprises a pressure sensor configured to measure a pressure inside the cooking container, wherein the physical state comprises a lid for the cooking container being closed, and wherein the method further comprises detecting the lid has been closed based on a pressure measurement received from the pressure sensor.
Clause 96. The method of any one of Clauses 90 to 95, further comprising detecting, using a fill level sensor of the cooking container, wherein the physical state comprises a fill level of the cooking container detected by the processor based on a signal received from the fill level sensor after a liquid or one or more food ingredients has been added to the cooking container.
Clause 97. The method of any one of Clauses 90 to 96, wherein the method further comprises: communicatively coupling the cooking appliance to an appliance management server that maintains a social network; and transmitting, by the cooking appliance, a communication to the appliance management server to post information to the social network, the information including the physical state of the cooking appliance.
Clause 98. The method of any one of Clauses 90 to 97, wherein the cooking appliance further comprises a camera communicatively coupled to the processor and positioned to capture image data of an interior of the cooking container, wherein the method further includes the cooking appliance detecting a fill level of the cooking container based on the image data captured by the camera.
Clause 99. The method of any one of Clauses 90 to 98, wherein the method further comprises: receiving, by the cooking appliance from a user device, image data of an interior of the cooking container; and detecting, by the cooking appliance, a fill level of the cooking container based on the image data received from the user device.
Clause 100. A method comprising: detecting a parameter value applied to the cooking appliance, the cooking appliance comprising a light emitting element gauge including multiple light emitting elements, and a processor coupled to the gauge, the parameter value selected from a specified range of possible values for a parameter of the cooking appliance; and selectively turning on one or more of the multiple light emitting elements in the gauge based on the parameter value in proportion to the range of possible values.
Clause 101. The method of Clause 100, wherein the multiple light emitting elements comprise light emitting diodes (LEDs), and wherein selectively turning on one or more of the multiple LEDs comprises: calculating a number of the multiple LEDs to turn on based on a ratio between the parameter value and a difference between a maximum and minimum value in the range of possible values.
Clause 102. The method of Clause 100 or 101, wherein the parameter value is a value for a first parameter applied to the cooking appliance, and wherein the method further comprises detecting a second parameter value for a second parameter applied to the cooking appliance, the second parameter value selected from a second range of possible values for the second parameter; and selectively turning one or more of the multiple light emitting elements in the gauge based on the second parameter value in proportion to the second range of possible values.
Clause 103. The method of any one of Clauses 100 to 102, wherein the multiple light emitting elements comprise light emitting diodes (LEDs), and wherein the multiple LEDs include multiple first color LEDs and multiple second color LEDs, and wherein the method further comprises selectively turning on one or more of the first color LEDs based on the first parameter value and selectively turning on one or more of the second color LEDs based on the second parameter value.
Clause 104. The method of any one of Clauses 100 to 103, wherein the multiple light emitting elements comprise light emitting diodes (LEDs), and wherein, while the one or more LEDs are turned on based on the first parameter value, the method further comprises: receiving a command based on a user voice input to display the second parameter value; and in response to the command, selectively turning on the one or more LEDs based on the second parameter value.
Clause 105. The method of any one of Clauses 100 to 104, wherein the cooking appliance further comprises a base that is configured to support a cooking container and electronically couple to the cooking container to cause food in the cooking container to be cooked, and wherein the gauge is housed in the base, and wherein the method further comprises: detecting a physical item has been added to or removed from the base; determining the parameter value based on the detection; and applying the determined parameter value to the cooking appliance.
Clause 106. The method of any one of Clauses 100 to 105, wherein detecting the parameter value comprises detecting a dynamic parameter value, and wherein the method further comprises selectively turning on or turning off one or more of the light emitting elements as the dynamic parameter value changes.
Clause 107. A non-transitory computer readable medium including executable instructions which when executed by a processor of a cooking appliance configured the cooking appliance to perform the method of Clauses 41-74 and 90 to 106.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or subcombinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

The teachings of the invention provided herein can be applied to other systems, not necessarily the system described above. The elements and acts of the various examples described above can be combined to provide further implementations of the invention. Some alternative implementations of the invention can include not only additional elements to those implementations noted above, but also can include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. When statements or subject matter in an incorporated by reference conflict with statements or subject matter of this application, then this application shall control.

These and other changes can be made to the invention in light of the above Detailed Description. While the above description describes certain examples of the invention, and describes the best mode contemplated, no matter how detailed the above appears in the text, the invention can be practiced in many ways. Details of the system can vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A cooking appliance, comprising:
a scale;
a processor coupled to the scale; and
a non-transitory computer readable storage medium storing executable computer program instructions, the computer program instructions when executed by the processor causing the processor to:
detect, using the scale, weights of each of multiple ingredients of food added to a container associated with the cooking appliance;
receive a parameter of the cooking appliance for cooking the food; and
generate based on the weights and the received parameter, a recipe defining a process for cooking the food.

2. The cooking appliance of claim 1, wherein the computer program instructions when executed further cause the processor to:
receive a speech input;
extract, from the speech input, an identification of an ingredient of the multiple ingredients; and
store the weight of the ingredient in association with the identification.

3. The cooking appliance of claim 1, wherein receiving the parameter comprises receiving a voice command to change a setting of the cooking appliance, and wherein the computer program instructions when executed further cause the processor to change the setting of the cooking appliance in response to the voice command.

4. The cooking appliance of claim 3, further comprising:
extract from the voice command, a trigger word and a value;
wherein changing the setting of the cooking appliance in response to the voice command comprises performing an action corresponding to the trigger word and quantified by the value.

5. The cooking appliance of claim 1, wherein the computer program instructions when executed further cause the processor to:
detect a rate at which an ingredient of the multiple ingredients is added to the container;
wherein the recipe further specifies the rate.

6. The cooking appliance of claim 1, wherein the computer program instructions when executed further cause the processor to:
capture a motion performed by a user while the user uses the cooking appliance to prepare the food;
wherein the recipe further specifies the motion.

7. The cooking appliance of claim 1, wherein the computer program instructions when executed further cause the processor to:
identify an order in which the multiple ingredients are added to the container;
wherein the recipe further specifies the order.

8. The cooking appliance of claim 1, wherein the computer program instructions when executed further cause the processor to:
detect by the scale, a user has stirred the food in the container;
wherein the recipe further identifies a time the user stirred the food relative to one or more other steps of the process for cooking the food.

9. The cooking appliance of claim 1, wherein the computer program instructions when executed further cause the processor to:
display a first datum on a display associated with the cooking appliance;
detect a voice input from a user; and
responsive to detecting the voice input, display a second datum on the display.

10. The cooking appliance of claim 1, further comprising a camera coupled to the processor and positioned to capture image data of the container, wherein the computer program instructions when executed by the processor further cause the processor to detect a fill level in the container based on the image data received from the camera.

11. The cooking appliance of claim 1, further comprising
a base configured to support the cooking container and to electrically couple to the cooking container to cause food in the cooking container to be cooked, wherein the scale is housed in the base;
wherein the processor is further configured to:
detect a physical item has been added to or removed from the base using a weight measured by the scale; and
responsive to detecting the physical item has been added or removed, apply a setting to the cooking appliance, based on the detection of the physical item, to cook the food in the cooking container.

12. The cooking appliance of claim 11, further comprising a light emitting diode (LED) gauge in the base, the LED gauge including multiple LEDs, and wherein the processor is configured to:
selectively turn on one or more of the multiple LEDs based on a value of the setting applied to the cooking appliance relative to a range of possible values for the setting.

13. The cooking appliance of claim 11, wherein the physical item comprises the cooking container, and wherein detecting the cooking container has been added to or removed from the base comprises detecting a change in the weight measured by the scale that corresponds to an expected weight for the cooking container.

14. The cooking appliance of claim 11, wherein the physical item comprises the cooking container, and wherein the computer program code further causes the processor to detect the cooking container has been added to or removed from the base using an electrical signal transmitted between the cooking container and the base.

15. The cooking appliance of claim 11, wherein the physical item comprises a lid for the cooking container, and wherein detecting the lid has been added to or removed from the base comprises detecting a change in the weight measured by the scale that corresponds to an expected weight for the lid.

16. The cooking appliance of claim 11, wherein the physical item comprises a lid for the cooking container, and wherein the computer program code further causes the processor to detect the lid has been added to or removed from the base using an electrical signal transmitted between the lid and the cooking container.

17. The cooking appliance of claim 11, wherein the physical item comprises a liquid or one or more food ingredients added to the cooking container, and wherein the computer program code further causes the processor to detect a fill level of the container after the liquid or one or more food ingredients have been added.

18. The cooking appliance of claim 11, wherein the physical item comprises the cooking container, and wherein the computer program code further causes the processor to identify the cooking container based on at least one of detecting a weight of the cooking container or receiving an electrical signal from the cooking container.

19. A cooking appliance comprising:
a processor coupled to the scale; and
a non-transitory computer readable storage medium storing executable computer program instructions, the computer program instructions when executed by the processor causing the processor to:
receive at least a portion of a recipe, wherein the recipe defines a process for cooking food and an amount of at least a first ingredient in the recipe for the food;
determine an amount of the first ingredient added during execution of the recipe;
generate an instruction for cooking the food based on the amount of the first ingredient added; and
wirelessly output the instruction by the cooking appliance.

20. The cooking appliance of claim 19, wherein the cooking appliance comprises a scale coupled to the processor, wherein the processor is configured to determine the amount of the first ingredient by receiving a signal from the scale indicative of the weight measured of the first ingredient.

21. The cooking appliance of claim 19, wherein the processor is configured to determine the amount of the first ingredient by:
receiving at least one dimension of the first ingredient, the at least one dimension calculated based on a photograph of the first ingredient.

22. The cooking appliance of claim 19, wherein the recipe specifies an amount of a second ingredient, and wherein the processor is configured to generate the instruction to indicate to a user of the cooking appliance to use an amount of the second ingredient that is determined based on the amount of the second ingredient specified in the recipe and the amount of the first ingredient added.

23. The cooking appliance of claim 19, wherein the cooking appliance includes a container, and wherein the processor is configured to generate the instruction to:
determine an eating pattern of a user of the cooking appliance; and
recommend increasing or decreasing the amount of the first ingredient added to the container based on the eating pattern.

24. The cooking appliance of claim 19, wherein the cooking appliance includes a container, and wherein the processor is configured to generate the instruction to:
receive an input specifying a number of servings of the food to be made; and
recommend increasing or decreasing the amount of the first ingredient added to the container based on the number of servings.

25. The cooking appliance of claim 19, wherein the processor is configured to generate the instruction to:
determine a rate at which a user is adding the first ingredient; and
instruct the user to decrease the rate.

26. The cooking appliance of claim 19, wherein generating the instruction is configured to instruct a user to stir the food.

27. The cooking appliance of claim 19, wherein the cooking appliance is communicatively coupled to another cooking appliance, and wherein the processor is configured to generate the instruction to generate a command to cause the other cooking appliance to perform an action.

28. The cooking appliance of claim 19, wherein the processor is configured to announce, a status of the other cooking appliance.

29. The cooking appliance of claim 19, wherein the recipe further specifies a parameter for cooking the food, and wherein the processor is configured to:
apply a setting to the cooking appliance based on the parameter and the amount of the first ingredient added;
access a stored user preference; and
apply the setting further based on the user preference.

30. The cooking appliance of claim 19, wherein the processor is configured to:
output information about the cooking appliance or the process for cooking the food to a server;
receive from the server, customer support or chef support generated based on the information about the cooking appliance or the process for cooking the food; and
generate the instruction further based on the customer support or chef support.

31. The cooking appliance of claim 30, wherein the cooking appliance is further configured to receive from the server, a recommended recipe selected by the server based on the output information.

32. The cooking appliance of claim 19, further comprising
a base configured to support the cooking container and to electrically couple to the cooking container to cause food in the cooking container to be cooked,
a scale housed in the base;
wherein the processor is further configured to:
detect a physical item has been added to or removed from the base using a weight measured by the scale; and
responsive to detecting the physical item has been added or removed, apply a setting to the cooking appliance, based on the detection of the physical item, to cook the food in the cooking container.

33. The cooking appliance of claim 32, further comprising a light emitting diode (LED) gauge in the base, the LED gauge including multiple LEDs, and wherein the processor is configured to:
selectively turn on one or more of the multiple LEDs based on a value of the setting applied to the cooking appliance relative to a range of possible values for the setting.

34. The cooking appliance of claim 32, wherein the physical item comprises the cooking container, and wherein detecting the cooking container has been added to or removed from the base comprises detecting a change in the weight measured by the scale that corresponds to an expected weight for the cooking container.

35. The cooking appliance of claim 32, wherein the physical item comprises the cooking container, and wherein the computer program code further causes the processor to detect the cooking container has been added to or removed from the base using an electrical signal transmitted between the cooking container and the base.

36. The cooking appliance of claim 32, wherein the physical item comprises a lid for the cooking container, and wherein detecting the lid has been added to or removed from the base comprises detecting a change in the weight measured by the scale that corresponds to an expected weight for the lid.

37. The cooking appliance of claim 32, wherein the physical item comprises a lid for the cooking container, and wherein the computer program code further causes the processor to detect the lid has been added to or removed from the base using an electrical signal transmitted between the lid and the cooking container.

38. The cooking appliance of claim 32, wherein the physical item comprises a liquid or one or more food ingredients added to the cooking container, and wherein the computer program code further causes the processor to detect a fill level of the container after the liquid or one or more food ingredients has been added.

39. The cooking appliance of claim 32, wherein the physical item comprises the cooking container, and wherein the computer program code further causes the processor to identify the cooking container based on at least one of detecting a weight of the cooking container or receiving an electrical signal from the cooking container.

40. A system comprising:
a cooking appliance configured according to claim 1; and
another cooking appliance configured according to claim 19;
wherein the processor of the cooking appliance is configured to transfer the instruction to generate a command to cause the another cooking appliance to perform an action.

41. A method, comprising:
detecting, at a cooking appliance which comprises a scale, weights of each of multiple ingredients of food added to a container associated with the cooking appliance;
receiving, at the cooking appliance, a parameter of the cooking appliance for cooking the food; and
generating, by the cooking appliance and based on the weights and the received parameter, a recipe defining a process for cooking the food.

42. The method of claim 41, wherein the method further comprises:
receiving, by the cooking appliance, a speech input;
extracting, by the cooking appliance from the speech input, an identification of an ingredient of the multiple ingredients; and
storing, by the cooking appliance, the weight of the ingredient in association with the identification.

43. The method of claim 41, wherein receiving the parameter comprises receiving a voice command to change a setting of the cooking appliance in response to the voice command.

44. The method of claim 43, further comprising:
extracting, by the cooking appliance from the voice command, a trigger word and a value;
wherein changing the setting of the cooking appliance in response to the voice command comprises performing, by the cooking appliance, an action corresponding to the trigger word and quantified by the value.

45. The method of claim 41, wherein the method further comprises:
detecting a rate at which an ingredient of the multiple ingredients is added to the container;
wherein the recipe further specifies the rate.

46. The method of claim 41, wherein the method further comprises:
capturing, by the cooking appliance, a motion performed by a user while the user uses the cooking appliance to prepare the food;
wherein the recipe further specifies the motion.

47. The method of claim 41, wherein the method further comprises:
Identifying, by the cooking appliance, an order in which the multiple ingredients are added to the container;
wherein the recipe further specifies the order.

48. The method of claim 41, wherein the method further comprises:
detecting by a scale of the cooking appliance, a user has stirred the food in the container;
wherein the recipe further identifies a time the user stirred the food relative to one or more other steps of the process for cooking the food.

49. The method of claim 41, wherein the method further comprises:
displaying a first datum on a display associated with the cooking appliance;
detecting a voice input from a user; and
responsive to detecting the voice input, displaying a second datum on the display.

50. The method of claim 41, further comprising:
capturing image data of a container of the cooking appliance using a camera of the cooking appliance; and
detecting, by the cooking appliance, a fill level in the container based on the image data received from the camera.

51. The method of claim 41, further comprising:
detecting a physical item has been added to or removed from a base of the cooking appliance using a weight measured by the scale, wherein the base is configured to support the cooking container and to electrically couple to the cooking container to cause food in the cooking container to be cooked, wherein the scale is house in the base; and
responsive to detecting the physical item has been added or removed, applying a setting to the cooking appliance, based on the detection of the physical item, to cook the food in the cooking container.

52. The method of claim 51, wherein the cooking appliance further comprises a light emitting diode (LED) gauge in the base, the LED gauge including multiple LEDs, and wherein the method further comprises:
selectively turning on one or more of the multiple LEDs based on a value of the setting applied to the cooking appliance relative to a range of possible values for the setting.

53. The method of claim 51, wherein the physical item comprises the cooking container, and wherein detecting the cooking container has been added to or removed from the base comprises detecting a change in the weight measured by the scale that corresponds to an expected weight for the cooking container.

54. The method of claim 51, wherein the physical item comprises the cooking container, and wherein the method comprises detecting that the cooking container has been added to or removed from the base using an electrical signal transmitted between the cooking container and the base.

55. The method of claim 51, wherein the physical item comprises a lid for the cooking container, and wherein detecting the lid has been added to or removed from the base comprises detecting a change in the weight measured by the scale that corresponds to an expected weight for the lid.

56. The method of claim 51, wherein the physical item comprises a lid for the cooking container, and wherein the method further comprises causing the processor to detect the lid has been added to or removed from the base using an electrical signal transmitted between the lid and the cooking container.

57. The method of claim 51, wherein the physical item comprises a liquid or one or more food ingredients added to the cooking container, and wherein the method further comprises causing the processor to detect a fill level of the container after the liquid or one or more food ingredients has been added.

58. The method of claim 51, wherein the physical item comprises the cooking container, and wherein the method further comprises causing the processor to identify the cooking container based on at least one of detecting a weight of the cooking container or receiving an electrical signal from the cooking container.

59. A method comprising:
receiving at a cooking appliance, at least a portion of a recipe, wherein the recipe defines a process for cooking food and an amount of at least a first ingredient in the recipe for the food;
determining by the cooking appliance, an amount of the first ingredient added during execution of the recipe;
generating an instruction for cooking the food based on the amount of the first ingredient added; and
wirelessly outputting the instruction by the cooking appliance.

60. The method of claim 59, wherein the cooking appliance comprises a scale, and wherein determining the amount of the first ingredient comprises:
measuring a weight of the first ingredient by the scale.

61. The method of claim 59, wherein determining the amount of the first ingredient comprises:
receiving at least one dimension of the first ingredient, the dimension calculated based on a photograph of the first ingredient.

62. The method of claim 59, wherein the recipe specifies an amount of a second ingredient, and wherein generating the instruction comprises:
instructing a user of the cooking appliance to use an amount of the second ingredient that is determined based on the amount of the second ingredient specified in the recipe and the amount of the first ingredient added.

63. The method of claim 59, wherein the cooking appliance includes a container, and wherein generating the instruction comprises:
determining an eating pattern of a user of the cooking appliance; and
recommending increasing or decreasing the amount of the first ingredient added to the container based on the eating pattern.

64. The method of claim 59, wherein the cooking appliance includes a container, and wherein generating the instruction comprises:
receiving an input specifying a number of servings of the food to be made; and
recommending increasing or decreasing the amount of the first ingredient added to the container based on the number of servings.

65. The method of claim 59, wherein generating the instruction comprises:
determining a rate at which a user is adding the first ingredient; and
instructing the user to decrease the rate.

66. The method of claim 59, wherein generating the instruction comprises instructing a user to stir the food.

67. The method of claim 59, wherein the cooking appliance is communicatively coupled to another cooking appliance, and wherein generating the instruction comprises generating a command to cause the other cooking appliance to perform an action.

68. The method of claim 67, further comprising announcing by the cooking appliance, a status of the other cooking appliance.

69. The method of claim 59, wherein the recipe further specifies a parameter for cooking the food, and wherein the method further comprises:
applying a setting to the cooking appliance based on the parameter and the amount of the first ingredient added;
accessing a stored user preference; and
applying the setting further based on the user preference.

70. The method of claim 59, further comprising:
outputting information about the cooking appliance or the process for cooking the food to a server;
receiving from the server, customer support or chef support generated based on the information about the cooking appliance or the process for cooking the food; and
generating the instruction further based on the customer support or chef support.

71. The method of claim 70, wherein the server is configured to award a prize based on the output information.

72. The method of claim 70, wherein the server maintains a chat log, and wherein outputting the information to the server comprises posting the information to the chat log.

73. The method of claim 70, further comprising receiving from the server, a recommended recipe selected by the server based on the output information.

74. The method of claim 70, wherein the server outputs a conversation thread for display to a user of the cooking appliance, the conversation thread including at least one of the customer support, the chef support, or the instruction for cooking the food.

75. A cooking appliance, comprising:
a base configured to support a cooking container and to electrically couple to the cooking container to cause food in the cooking container to be cooked;
a scale housed in the base; and
a processor coupled to the scale, the processor executing computer program code that causes the processor to:
detect a physical item has been added to or removed from the base using a weight measured by the scale; and
responsive to detecting the physical item has been added or removed, apply a setting to the cooking appliance, based on the detection of the physical item, to cook the food in the cooking container.

76. The cooking appliance of claim 75, further comprising a light emitting diode (LED) gauge in the base, the LED gauge including multiple LEDs, and wherein the computer program code when executed further causes the processor to:
selectively turn on one or more of the multiple LEDs based on a value of the setting applied to the cooking appliance relative to a range of possible values for the setting.

77. The cooking appliance of claim 75, wherein the physical item comprises the cooking container, and wherein detecting the cooking container has been added to or removed from the base comprises detecting a change in the weight measured by the scale that corresponds to an expected weight for the cooking container.

78. The cooking appliance of claim 75, wherein the physical item comprises the cooking container, and wherein the computer program code further causes the processor to detect the cooking container has been added to or removed from the base using an electrical signal transmitted between the cooking container and the base.

79. The cooking appliance of claim 75, wherein the physical item comprises a lid for the cooking container, and wherein detecting the lid has been added to or removed from the base comprises detecting a change in the weight measured by the scale that corresponds to an expected weight for the lid.

80. The cooking appliance of claim 75, wherein the physical item comprises a lid for the cooking container, and wherein the computer program code further causes the processor to detect the lid has been added to or removed from the base using an electrical signal transmitted between the lid and the cooking container.

81. The cooking appliance of claim 75, wherein the physical item comprises a liquid or one or more food ingredients added to the cooking container, and wherein the computer program code further causes the processor to detect a fill level of the container after the liquid or one or more food ingredients has been added.

82. The cooking appliance of claim 75, wherein the physical item comprises the cooking container, and wherein the computer program code further causes the processor to identify the cooking container based on at least one of detecting a weight of the cooking container or receiving an electrical signal from the cooking container.

83. A cooking appliance, comprising:
a light emitting element gauge including multiple light emitting elements; and
a processor coupled to the gauge and executing computer program code that causes the processor to:
detect a parameter value applied to the cooking appliance, the parameter value selected from a specified range of possible values for a parameter of the cooking appliance; and
selectively turn on one or more of the multiple light emitting elements in the gauge based on the parameter value in proportion to the range of possible values.

84. The cooking appliance of claim 83, wherein the multiple light emitting elements comprise light emitting diodes (LEDs), and wherein selectively turning on one or more of the multiple LEDs comprises:
calculating a number of the multiple LEDs to turn on based on a ratio between the parameter value and a difference between a maximum and minimum value in the range of possible values.

85. The cooking appliance of claim 83, wherein the parameter value is a value for a first parameter applied to the cooking appliance, and wherein the computer program code further causes the processor to:
detect a second parameter value for a second parameter applied to the cooking appliance, the second parameter value selected from a second range of possible values for the second parameter; and
selectively turn one or more of the multiple light emitting elements in the gauge based on the second parameter value in proportion to the second range of possible values.

86. The cooking appliance of claim 83, wherein the multiple light emitting elements comprise light emitting diodes (LEDs), and wherein the multiple LEDs include multiple first color LEDs and multiple second color LEDs, and wherein the processor selectively turns on one or more of the first color LEDs based on the first parameter value and selectively turns on one or more of the second color LEDs based on the second parameter value.

87. The cooking appliance of claim 83, wherein the multiple light emitting elements comprise light emitting diodes (LEDs), and wherein computer program code further causes the processor to, while the one or more LEDs are turned on based on the first parameter value:
receive a command based on a user voice input to display the second parameter value; and
in response to the command, selectively turning on the one or more LEDs based on the second parameter value.

88. The cooking appliance of claim 83, wherein the cooking appliance further comprises a base that is configured to support a cooking container and electronically couple to the cooking container to cause food in the cooking container to be cooked, and wherein the gauge is housed in the base, and wherein the computer program code further causes the processor to:
detect a physical item has been added to or removed from the base;
determine the parameter value based on the detection; and
apply the determined parameter value to the cooking appliance.

89. The cooking appliance of claim 83, wherein detecting the parameter value comprises detecting a dynamic parameter value, and wherein the processor selectively turns on or turns off one or more of the light emitting elements as the dynamic parameter value changes.

90. A method comprising:
detecting a physical state associated with the cooking appliance responsive to an electrical signal detected by a processor, wherein the cooking appliance comprises a base configured to support a cooking container and electrically couple to the cooking container to cause food in the cooking container to be cooked, and the processor housed in the base; and
responsive to detecting the physical state, applying a setting to the cooking appliance, based on the detected physical state, to cook the food in the cooking container.

91. The method of claim 90, wherein the cooking appliance further comprises one or more temperature sensors in the base and a heating element in the cooking container, wherein the electrical signal comprises a temperature signal generated by the one or more temperatures sensors and indicative of a temperature measurement at an exterior of the cooking container, and wherein the method comprises:
causing a determined amount of heat to be output by the heating element;
after a specified amount of time, detecting the temperature of the exterior of the cooking container using the temperature signal received from the one or more temperature sensors;
determining a thermal resistance of the cooking container based on the temperature detected at the exterior of the cooking container; and
applying the setting to the cooking appliance based on the determined thermal resistance.

92. The method of claim 90, wherein the cooking appliance further comprises a light emitting diode (LED) gauge in the base, the LED gauge including multiple LEDs, wherein the method further comprises:
selectively turning on one or more of the multiple LEDs based on a value of the setting applied to the cooking appliance relative to a range of possible values for the setting.

93. The method of claim 90, wherein the physical state comprises the cooking container being coupled to the base, and wherein the method comprises detecting the cooking container is coupled to the base using an electrical signal transmitted between the cooking container and the base.

94. The method of claim 90, wherein the physical state comprises a lid for the cooking container being closed, and wherein the method comprises detecting the lid has been closed using an electrical signal transmitted between the lid and the cooking container.

95. The method of claim 90, wherein the cooking appliance further comprises a pressure sensor configured to measure a pressure inside the cooking container, wherein the physical state comprises a lid for the cooking container being closed, and wherein the method further comprises detecting the lid has been closed based on a pressure measurement received from the pressure sensor.

96. The method of claim 90, further comprising detecting, using a fill level sensor of the cooking container, wherein the physical state comprises a fill level of the cooking container detected by the processor based on a signal received from the fill level sensor after a liquid or one or more food ingredients has been added to the cooking container.

97. The method of claim 90, wherein the method further comprises:
communicatively coupling the cooking appliance to an appliance management server that maintains a social network; and
transmitting, by the cooking appliance, a communication to the appliance management server to post information to the social network, the information including the physical state of the cooking appliance.

98. The method of claim 90, wherein the cooking appliance further comprises a camera communicatively coupled to the processor and positioned to capture image data of an interior of the cooking container, wherein the method further includes the cooking appliance detecting a fill level of the cooking container based on the image data captured by the camera.

99. The method of claim 90, wherein the method further comprises:
receiving, by the cooking appliance from a user device, image data of an interior of the cooking container; and
detecting, by the cooking appliance, a fill level of the cooking container based on the image data received from the user device.

100. A method comprising:
detecting a parameter value applied to the cooking appliance, the cooking appliance comprising a light emitting element gauge including multiple light emitting elements, and a processor coupled to the gauge, the parameter value selected from a specified range of possible values for a parameter of the cooking appliance; and
selectively turning on one or more of the multiple light emitting elements in the gauge based on the parameter value in proportion to the range of possible values.

101. The method of claim 100, wherein the multiple light emitting elements comprise light emitting diodes (LEDs), and wherein selectively turning on one or more of the multiple LEDs comprises:
calculating a number of the multiple LEDs to turn on based on a ratio between the parameter value and a difference between a maximum and minimum value in the range of possible values.

102. The method of claim 100, wherein the parameter value is a value for a first parameter applied to the cooking appliance, and wherein the method further comprises
detecting a second parameter value for a second parameter applied to the cooking appliance, the second parameter value selected from a second range of possible values for the second parameter; and
selectively turning one or more of the multiple light emitting elements in the gauge based on the second parameter value in proportion to the second range of possible values.

103. The method of claim 100, wherein the multiple light emitting elements comprise light emitting diodes (LEDs), and wherein the multiple LEDs include multiple first color LEDs and multiple second color LEDs, and wherein the method further comprises selectively turning on one or more of the first color LEDs based on the first parameter value and selectively turning on one or more of the second color LEDs based on the second parameter value.

104. The method of claim 100, wherein the multiple light emitting elements comprise light emitting diodes (LEDs), and wherein, while the one or more LEDs are turned on based on the first parameter value, the method further comprises:
receiving a command based on a user voice input to display the second parameter value; and
in response to the command, selectively turning on the one or more LEDs based on the second parameter value.

105. The method of claim 100, wherein the cooking appliance further comprises a base that is configured to support a cooking container and electronically couple to the cooking container to cause food in the cooking container to be cooked, and wherein the gauge is housed in the base, and wherein the method further comprises:
detecting a physical item has been added to or removed from the base;
determining the parameter value based on the detection; and
applying the determined parameter value to the cooking appliance.

106. The method of claim 100, wherein detecting the parameter value comprises detecting a dynamic parameter value, and wherein the method further comprises selectively turning on or turning off one or more of the light emitting elements as the dynamic parameter value changes.

107. A non-transitory computer readable medium including executable instructions which when executed by a processor of a cooking appliance configured the cooking appliance to perform the method of any one of claims 41, 59, 90 and 100.
